(19) United States
(12) Patent Application Publication
(10) Pub. No.: US 2026/0257846 A1
(43) Pub. Date: Sep. 3, 2026

(54) BIODEGRADABLE FLEXIBLE PACKAGE WITH A LIQUID FOOD COMPOSITION

(71) Applicant: THE PROCTER & GAMBLE COMPANY, Cincinnati, OH (US)

(72) Inventors: Emily Charlotte BOSWELL, Wyoming, OH (US); Jodi Lee BROWN, Cincinnati, OH (US); Patti Jean KELLETT, Cincinnati, OH (US); Valerie WONG, Mason, OH (US); John Moncrief LAYMAN, Middletown, OH (US); Stefano BARTOLUCCI, Bad Homburg (DE); Jessa Leigh MEYERS, Cincinnati, OH (US); Zhan CHENG, Beijing (CN); Wandi ZHOU, Beijing (CN); Sheena Marie MAHRLE, Hamilton, OH (US); Robert Michael PETTIFER, Mariemont, OH (US)

(21) Appl. No.: 19/642,807

(22) Filed: Apr. 9, 2026

Related U.S. Application Data
(63) Continuation of application No. PCT/CN2024/124212, filed on Oct. 11, 2024.

(30) Foreign Application Priority Data
Oct. 11, 2023 (WO) PCT/CN2023/124056

(51) Int. Cl. B65D 65/46; A23L 19/00; A23L 21/25; A23L 25/10; A23L 27/60; B32B 7/12; B32B 27/10; B65D 75/26; B65D 85/72

(52) U.S. Cl. CPC B65D 65/466; A23L 19/09; A23L 21/25; A23L 25/10; A23L 27/63; B32B 7/12; B32B 27/10; B65D 75/26; B65D 85/72; B32B 2255/10; B32B 2255/205; B32B 2307/7163; B32B 2439/70

(57) ABSTRACT

The present invention is directed to a biodegradable flexible package in combination with a liquid food composition comprising a package comprising at least one biodegradable polymeric layer and an inorganic layer; and a liquid food composition comprising from about 0% to about 50% water and from about 0% to about 50% of a humectant; wherein there is a Water Activity (Aw) of about 0.30 to about 0.90.

### FIELD OF THE INVENTION

The present invention is directed to a biodegradable flexible package in combination with a food composition with low water activity and low water content.

### BACKGROUND OF THE INVENTION

Sachets are small-format, plastic packages that enable consumers to access consumer products with low cash outlay and are typically unit/low dose packaging. Conventionally, these sachets are generally multi-material laminates made of polyethylene terephthalate (PET), biaxially oriented polypropylene (BOPP) and polyethylene (PE), partly metallized or containing a foil layer and are considered both hard-to-recycle and highly persistent if they enter the environment. Significant post-consumer sachet waste today is ending up either burned or entering the sea/soil, due to under-developed waste management systems, and having no/negative after-use value.

No solution has yet been found for unit/low dose liquid products in particular, where the packaging/product also has a desirable consumer, business, technical and end of life (environmental) profile.

To solve this problem, the present invention identifies a way to market liquid foods inside sachets made from specific types of biodegradable flexible structures that would make it less persistent than today's sachet packaging, whilst maintaining a reasonable product shelf life. However, it is not simple to place today's liquid foods inside sachets made from such biodegradable flexible structures, because historically it has been seen that liquid products with high water content & high water activity will damage the less persistent biodegradable flexible structures too quickly to enable a useful shelf life through the existing distribution & supply chains in various markets, even when the biodegradable flexible structures contains multiple layers including barrier layers. Typically, such markets require a shelf life of up to 1 or 2 years, whilst the packages routinely experience environments such as 40 C & 75% RH, if not higher. However, typically the following events may occur when placing typical in-market liquid foods (with high water content & high water activity) inside biodegradable flexible packaging: a) Early hydrolysis of the biodegradable polymeric layer (that acts as the sealant for the package) in direct contact with the liquid product causes a significant drop in the polymer molecular weight, making the sachet material weaker & more porous; b) The weakened sealant then allows moisture & water to move through it at a higher rate into other layers of the biodegradable flexible structure that may be present further into the structure. In particular, any metallized barrier layers present typically undergo significant corrosion and damage when this occurs. This corrosion and damage may contribute to even higher moisture & water loss from the sachet; and/or c) High water content in the formulation leads to a high driving force for moisture to leave the package to equilibrate with the outside atmosphere, resulting in high overall weight loss, drying up of the product inside the package & a significant increase in the product viscosity which eventually makes the product unusable. If any or all of the above occurs, this will lead to a decreased product shelf life that may not be sufficient enough for the typical distribution systems that consumer goods move through, and this can subsequently result in the consumer experiencing poor product performance.

For liquid foods specifically, although one solution could be to switch to dry foods, it could be challenging to move the majority of consumers to dry foods immediately (many may never move) and these solutions typically require new and expensive capital investments to manufacture the product and packaging.

To make any further progress with making biodegradable sachets that can hold liquid food products, the present invention has found that there is a need to understand whether the foods could in fact be altered sufficiently in order to be less damaging to specific types of biodegradable flexible packaging, whilst the product still remains a liquid with low enough viscosity to meet the requirements of certain cooking recipes and food preparation needs.

The present invention is directed to a combination of known liquid food formulations or new liquid food compositions (with lower water activity and lower water content than the typical liquid foods in the market today, which are less harmful to the biodegradable flexible packaging) coupled with specific types of biodegradable flexible packaging having sufficient Water Vapor Transmission Rate WVTR barrier to minimize weight loss (and hence help to maintain a sufficient shelf life), whilst also being able to pass specific types of biodegradation test to ensure that it would not be persistent if it escaped into the environment after the sachet package has been used and disposed of. Typically, the present invention has worked to match the water activity of the product to come close to the average humidity in the environment where the product is sold, to minimize either weight loss or weight gains. In some cases, work has been done to lower the water activity of the product even further to enable it to be placed within biodegradable flexible packaging with yet worse Water Vapor Transmission Rate (WVTR) barrier, where weight gain is manageable but weight loss is typically not observed. The solution described enables the marketing of liquid foods that still delight the consumer, inside sachet packaging made from biodegradable flexible structures that are less persistent than today's flexible sachet packaging—that still enables a reasonable product shelf life (1-2 years) to enable the product to be suitable for consumer usage, even after passing through the typical distribution systems of a typical consumer food goods company, from plant to distribution centers to shops to the consumer.

### SUMMARY OF THE INVENTION

The present invention is directed to a biodegradable flexible package in combination with a liquid food composition comprising a package comprising at least one biodegradable polymeric layer and an inorganic layer; and a liquid food composition comprising from about 0% to about 50% water and from about 0% to about 50% of a humectant; wherein there is a Water Activity (Aw) of about 0.30 to about 0.90.

### BRIEF DESCRIPTION OF THE DRAWINGS

FIG. 1a is depicting a non-limiting example of a sachet which is an isometric view with cross section line reference (1B-1B).

FIG. 1b depicts a cross section view of Structure 1.

FIG. 2 depicts a cross-section view of Structure 2.

FIG. 3 depicts cross-section view of Structure 3.

FIG. 4 depicts a cross-section view of Structure 4.

FIG. 5 depicts a cross-section view of Structure 5.

FIG. 6 depicts a cross-section view of Structure 6.

FIG. 7 depicts a cross-section view of Structure 7.

FIG. 8 depicts a cross-section view of Structure 8.

FIG. 9 depicts a cross-section view of Structure 9.

FIG. 10 depicts a cross-section view of Structure 10.

FIG. 11 depicts a cross-section view of Structure 11.

FIG. 12 depicts a cross-section view of Structure 12.

FIG. 13 depicts a cross-section view of Structure 13.

FIG. 14 depicts a cross-section view of Structure 14.

FIG. 15 depicts a cross-section view of Structure 15.

FIG. 16 depicts a cross-section view of Structure 16.

FIG. 17 depicts a cross-section view of Structure 17.

### DETAILED DESCRIPTION OF EMBODIMENTS OF THE INVENTION

All percentages and ratios used herein are by weight of the total composition, unless otherwise designated. All measurements are understood to be made at ambient conditions, where “ambient conditions” means conditions at about 25° C., under about one atmosphere of pressure, and at about 50% relative humidity, unless otherwise designated. All numeric ranges are inclusive of narrower ranges; delineated upper and lower range limits are combinable to create further ranges not explicitly delineated.

The compositions of the present invention can comprise, consist essentially of, or consist of, the essential components as well as optional ingredients described herein. As used herein, “consisting essentially of” means that the composition or component may include additional ingredients, but only if the additional ingredients do not materially alter the basic and novel characteristics of the claimed compositions or methods.

“Apply” or “application,” as used in reference to a composition, means to apply or spread the compositions of the present invention onto keratinous tissue such as the hair.

“Safe and effective amount” means an amount of a compound or composition sufficient to significantly induce a positive benefit.

The term “preservation” in the context of the present invention refers to the prevention or retardation of product deterioration due to microorganisms present in the product or composition. A “preservative agent” or “preservative” in the context of the present invention is a substance that prevents or retards the growth of microorganisms in a product or composition.

While the specification concludes with claims particularly pointing out and distinctly claiming the invention, it is believed that the present invention will be better understood from the following description.

As used herein, the term “fluid” includes liquids and gels.

As used herein, the articles including “a” and “an” when used in a claim, are understood to mean one or more of what is claimed or described.

As used herein, “comprising” means that other steps and other ingredients which do not affect the end result can be added. This term encompasses the terms “consisting of” and “consisting essentially of”.

As used herein, “mixtures” is meant to include a simple combination of materials and any compounds that may result from their combination.

As used herein, “molecular weight” or “Molecular weight” refers to the weight average molecular weight unless otherwise stated. Molecular weight is measured using industry standard method, gel permeation chromatography (“GPC”).

Where amount ranges are given, these are to be understood as being the total amount of said ingredient in the composition, or where more than one species fall within the scope of the ingredient definition, the total amount of all ingredients fitting that definition, in the composition.

For example, if the composition comprises from 1% to 5% fatty alcohol, then a composition comprising 2% stearyl alcohol and 1% cetyl alcohol and no other fatty alcohol, would fall within this scope.

The amount of each particular ingredient or mixtures thereof described hereinafter can account for up to 100% (or 100%) of the total amount of the ingredient(s) in the liquid food composition.

As used herein, a “food composition” means any nutritious substance that people or animals eat or drink or that plants absorb in order to maintain life and growth, including, but not limited to, products such as honey, fruit spread, fruit sauce, peanut butter, ketchup, mayonnaise, mustard, applesauce, hot sauce, jams, marmalades, sandwich spreads, sauces, salad dressings, seasonings, syrups, jellies, other condiments and edible food compositions, and all combinations thereof.

As used herein, the terms “include,” “includes,” and “including,” are meant to be non-limiting and are understood to mean “comprise,” “comprises,” and “comprising,” respectively.

All percentages, parts and ratios are based upon the total weight of the compositions of the present invention, unless otherwise specified. All such weights as they pertain to listed ingredients are based on the active level and, therefore, do not include carriers or by-products that may be included in commercially available materials.

Unless otherwise noted, all component or composition levels are in reference to the active portion of that component or composition, and are exclusive of impurities, for example, residual solvents or by-products, which may be present in commercially available sources of such components or compositions.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

As used herein, “Bio-polymers” or “Bio-plastics” are meant to include polymers derived from biological materials, typically plant materials.

As used herein, “Biodegradable” is meant to include materials that are susceptible to being assimilated by microorganisms, such as molds, fungi, and bacteria when the biodegradable material is buried in the ground or otherwise contacts the microorganisms (including contact under environmental conditions conducive to the growth of the microorganisms). When something is biodegradable it is meant that the entire structure plus all major components pass either one or more of the biodegradation tests listed below. A component is considered a major component if it makes up >10 wt % of the entire structure.

As used herein, “readily biodegradable” or “inherently biodegradable” refers to materials that meet the pass levels for ready biodegradability or inherent biodegradability according to the OECD Guideline for Testing of Chemicals, Method 301 B: CO2 Evolution (Modified Sturm Test) (adopted Jul. 17, 1992).

As used herein, “home compostable” refers to materials that meet the pass levels for the OK compostable HOME OK-02e certification by TÜV AUSTRIA (2012). Alternately, other composting tests that follow similar testing requirements to this may be used, such as the Australian Standard AS 5810—2010 for Biodegradable plastics—“Biodegradable plastics suitable for home composting”.

As used herein, “industrially compostable” refers to materials that meet the pass levels for the OK compostable INDUSTRIAL OK-02e certification by TÜV AUSTRIA (2012).

As used herein, passing “Aerobic biodegradation test in marine sediment” refers to materials that when tested reach at least 50% biodegradation in 150 days when placed in biodegradation testing according to ISO23832 at 25 C.

As used herein, “Copolymer” is meant to include a polymer derived from two or more polymerizable monomers. When used in generic terms the term “copolymer” is also inclusive of more than two distinct monomers, for example, ter-polymers. The term “copolymer” is also inclusive of random copolymers, block copolymers, and graft copolymers.

As used herein, “Cross machine direction” or “CD” is meant to include the width of film, i.e., a direction generally perpendicular to the MD.

As used herein, “Film” is meant to include a sheet-like material wherein the length and width of the material far exceed the thickness of the material. As used herein, the terms “film” and “sheet” are used interchangeably.

As used herein, “Machine direction” or MD is meant to include the length of film as it is produced.

As used herein, “Renewable” is meant to include a material that can be produced or is derivable from a natural source which is periodically (e.g., annually or perennially) replenished through the actions of 15 plants of terrestrial, aquatic or oceanic ecosystems (e.g., agricultural crops, edible and non-edible grasses, forest products, seaweed, or algae), or microorganisms (e.g., bacteria, fungi, or yeast).

As used herein, “recyclable” refers to used paper, including in-plant and post-consumer waste paper and paperboard, which is capable of being processed into new paper or paperboard using the process defined in the Voluntary Standard for Repulping and Recycling Corrugated Fiberboard Treated to Improve its Performance in the Presence of Water and Water Vapor (Aug. 16, 2013).

As used herein, “flexible” refers to capable of bending easily without breaking.

As used herein, “inorganic layer” refers to not consisting of or deriving from living matter.

As used herein, “water-soluble” refers to the ability of a sample material to completely dissolve in or disperse into water leaving no visible solids or forming no visibly separate phase, when at least about 25 grams, at least about 50 grams, at least about 100 grams, at least about 200 grams, of such material is placed in one liter (1 L) of deionized water at 20° C. and under the atmospheric pressure with sufficient stirring.

### Water In-Soluble Biodegradable Polymers for Sealant Layers and Other Layers

In the present invention, there may be a biodegradable polymeric layer in contact with the product (typically called the sealant or sealant layer or heat sealant layer) that is made from a water in-soluble biodegradable polymer. In the packaging industry, these materials are commonly referred to as “bio-plastics” as well as “bio-polymers” or “biodegradable polymers”. In some structures, such a biodegradable polymeric layer could also be suitable to act as a lamination layer between other layers such as the paper layer and the sealant layer. If a polymer is regarded as biodegradable after being tested, it is considered to be less persistent than non-biodegradable polymers, in the environment of relevance to the test performed.

In the present invention, the water in-soluble biodegradable polymer may be a thermoplastic polymer. Thermoplastic polymers, as used herein, are polymers that melt and then, upon cooling, crystallize or harden, but can be re-melted upon further heating. Suitable thermoplastic polymers for use herein typically have a melting temperature from 60° C. to 300° C., from 80° C. to 250° C., or from 100° C. to 215° C. The molecular weight of the thermoplastic polymer is sufficiently high to enable entanglement between polymer molecules and yet low enough to be melt extrudable, if needed. Suitable thermoplastic polymers can have weight average molecular weights of 1000 kDa or less, 5 kDa to 800 kDa, 10 kDa to 700 kDa, or 20 kDa to 400 kDa. The weight average molecular weight is determined by the specific ASTM method for each polymer, but is generally measured using either gel permeation chromatograph (GPC) or from solution viscosity measurements.

In the present invention, there may be some situations in which a non-thermoplastic polymer needs to be used for a specific layer within the structure. One example of this when a cellulose film is required in the structure. Most biodegradable cellulose films are not thermoplastic but can only be purchased as a ready-made film (which is produced by solution casting, not thermoplastic extrusion) which would be laminated into the structure.

Suitable biodegradable polymers also include those biodegradable materials that are environmentally degradable using aerobic or anaerobic digestion procedures, or by virtue of being exposed to environmental elements such as sunlight, rain, moisture, wind, temperature, and the like.

The specific choice of this biodegradable polymer will depend on the specific product formulation that the polymer is in contact with. The choice of biodegradable polymer will also depend on the specific country and the likely end of life fate of the package once the product has been used up, since different polymers have different biodegradation rates. For example, some biodegradable polymers biodegrade fast enough and at low enough temperatures to biodegrade in home composting conditions (which typically run at lower temperatures than industrial compost heaps-lab tests to simulate home composting are typically run at 25 C or close to this temperature) and are more prevalent than industrial composting systems. However, some biodegradable polymers degrade much more slowly and require higher temperatures to initiate biodegradation and so are only suitable for disposal in industrial composting conditions (which typically run at much higher temperatures than home compost heaps-lab tests to simulate industrial composting are typically run at 58 C). Such composting systems are available in some countries, but not in all. On the other hand, some biodegradable polymers can biodegrade at temperature even lower than those observed in a home composting system and can in fact biodegrade if left in nature e.g., if they are left in or on soil, or in fresh water or sea water/sediment.

a) Biodegradable Aliphatic and/or Aromatic Polyesters

In the present invention, the possible biodegradable water in-soluble polymers could include biodegradable thermoplastic materials selected from the group consisting of aliphatic and/or aromatic polyesters. Such biodegradable aromatic and/or aliphatic polyesters can be either biologically produced (e.g., via large scale bacterial fermentation) or chemically synthesized. Biodegradable aliphatic and/or aromatic polyester suitable for the practice of the present invention can be a copolymer of: i) at least one aliphatic dicarboxylic acid; and/or ii) at least one aromatic dicarboxylic acid; and iii) a dihydroxy compound (diol).

The aliphatic dicarboxylic acid can be a C₂ to C₁₂ aliphatic dicarboxylic acid, such as succinic acid, glutaric acid, dimethyl glutaric acid, adipic acid, sebacic acid, or azelaic acid, and a derivative thereof (e.g., alkyl esters, acid chlorides, or their anhydrides). The aromatic dicarboxylic acid can be terephthalic acid or naphthalene dicarboxylic acid. The dihydroxy compound or diol can be a C₂-C₆ alkanediol or a C₅-C₁₀ cycloalkanediol (e.g., ethylene glycol, propylene glycol, 1,4-butanediol, 1,6-hexanediol, 1,4 cyclohexanedimethanol, and the like).

Examples of biodegradable aromatic and/or aliphatic polyesters include, but are not limited to: various co-polyesters of polyethylene terephthalate (PET) and polybutylene terephthalate (PBT) with aliphatic diacids or diols incorporated into the polymer backbone to render such co-polyesters biodegradable or compostable; and various aliphatic polyesters and co-polyesters derived from dibasic acids such as succinic acid, glutaric acid, adipic acid, sebacic acid, azelaic acid, or their derivatives (e.g., alkyl esters, acid chlorides, or their anhydrides), and diols such as ethylene glycol, propylene glycol, 1,4-butanediol, 1,6-hexanediol, 1,4 cyclohexanedimethanol, and the like. For example, the biodegradable aromatic and/or aliphatic polyester may be selected from the group consisting of polybutylene adipate terephthalate (PBAT), polybutylene succinate (PBS), polybutylene succinate adipate (PBSA), Polylactic Acid (PLA) and Polyhydroxyalkanoate (PHA) any combinations/mixtures thereof.

Information on examples of specific types of biodegradable aromatic and/or aliphatic polyesters are shown below:

### i) Examples of Polybutylene Adipate Terephthalate (PBAT):

Polybutylene adipate terephthalate (PBAT) is a copolymer of butylene adipate and butylene terephthalate, which combines the characteristics of PBA and PBT. Polybutylene terephthalate (PBAT) contains flexible fatty chains and rigid aromatic chains, thus having high toughness and high temperature resistance, and due to the presence of ester bonds, it is simultaneously biodegradable.

Examples of suppliers that market PBAT include BASF who market various grades of PBAT under the trade name ECOFLEX®; Novamont who market various grades under the trade name Origo-Bi®; Zhuhai Wango Chemical Co Ltd who market under the name Wango®; by JinHui Zhaolong as Ecoworld®; by Eastman Chemical as Eastar Bio; and by Xinjiang Blue Ridge Tunhe Polyester Co. Ltd and their PBAT products. Other suppliers in Asia now producing PBAT include Zhejiang Biodegradable Advanced Material Co. Ltd; Dongguan Xinhai Environmental Protection Material Co., Ltd.; Hangzhou Ruijiang Chemical Co., Ltd.; Red Avenue New Material Group Co., Ltd.; and Jiangsu Torise Biomaterials Co., Ltd (in China) plus Green Chemical Co., Ltd. and WILLEAP in South Korea.

### ii) Examples of Polybutylene Succinate (PBS) and Polybutylene Succinate Adipate (PBSA)

Polybutylene succinate (PBS) can be obtained by polycondensation of 1,4-butanediol and succinic acid. Polybutylene succinate/adipate (PBSA) is obtained by addition of adipic acid to 1,4-butanediol and succinic acid polycondensation.

Examples of suppliers that market various grades of PBS and PBSA include Mitsubishi Chemical Group (MCCP) who market under the tradename Bio-PBS™; PTTMCC Biochem (a joint venture company between PTT Global Chemical Public Company Limited (GC) and Mitsubishi Chemical Corporation (MCC)); Showa Denko who market under the tradename Bionelle™; Roquette; Succinity; and Xinjiang Blue Ridge Tunhe Polyester Co. Ltd with their PBS and PBSA grades.

iii) Examples of Polylactic Acid (PLA)

Polylactic acid, also known as poly(lactic acid) or polylactide (PLA), is a thermoplastic polyester with backbone formula (C₃H₄O₂ₙ or [—C(CH₃)HC(—O)O—]ₙ, formally obtained by condensation of lactic acid C(CH₃)(OH)HCOOH with loss of water. It can also be prepared by ring-opening polymerization of lactide [—C(CH₃)HC(═O)O—]₂, the cyclic dimer of the basic repeating unit. Polylactic acid typically requires Industrial Composting conditions to initiate biodegradation. However, it is one of the most resistant biopolymers to aggressive formulations. Therefore, it would most likely only be used for products that are the most aggressive.

The polylactic acid may generally be derived from monomer units of any isomer of lactic acid, the monomeric precursor of PLA. Lactic acid can be obtained either by carbohydrate fermentation or by common chemical synthesis. Also known as “milk acid”, lactic acid is the simplest hydroxyl acid with an asymmetric carbon atom and two optically active configurations, namely the L and D isomers, which can be produced in bacterial systems, whereas mammalian organisms only produce the L isomer, which is easily assimilated during metabolism.

Lactic acid is mainly prepared by the bacterial fermentation of carbohydrates. These fermentation processes can be classified according to the type of bacteria used. Most fermentation processes use species of Lactobacilli which give high yields of lactic acid. Some organisms predominantly produce the L isomer, such as Lactobacilli amylophilius, L. bavaricus, L. cosei, and L. maltaromicus, whereas L. delbrueckii, L. jensenii or L. acidophilus produce the D isomer or a mixture of L and D.

Synthesis of PLA is a multi-step process which can follow at least three main routes. In one production route, lactic acid is condensation polymerized to yield a low molecular weight, brittle polymer which, for the most part, is unusable, unless external coupling agents are employed to increase its chains length. The second route is the azeotropic dehydrative condensation of lactic acid. This can yield high molecular weight PLA without the use of chain extenders or special adjuvents. The third and main process involves the intermediate step of forming lactides from the lactic acid, which are then subjected to ring-opening polymerization (ROP) to obtain high molecular weight PLA.

The polylactic acid may be a homopolymer or a copolymer, such as one that contains monomer units derived from L-lactic acid (these may be named PLLA in some instances). and monomer units derived from D-lactic acid (these may be named PDLA in some instances). Multiple polylactic acids, each having a different ratio between the monomer unit derived from L-lactic acid and the monomer unit derived from D-lactic acid, may be included at any desired percentage.

The physical properties of polylactide are related to the enantiomeric purity of lactic acid stereo-copolymers. The physical properties of polylactide are related to the enantiomeric purity of the lactic acid stereo-copolymers. Homo PLA is a linear macromolecule with a molecular architecture that is determined by its stereochemical composition. PLA can be produced that is totally amorphous or up to 40% crystalline. PLA resins containing more than 93% of L-lactic acid are semi-crystalline, but PLA having 50 to 93% L-lactic acid is completely amorphous. Thus, the L/D ratio induces or restrains polymer crystallinity.

In the present invention there may be different density data for PLA, as crystalline parts can have a density of 1.29 compared to 1.25 for the amorphous material. PLA is a slowly crystallizing polymer similar to PET. As with PET, PLA can be oriented by processing. Chain orientation increases the mechanical strength of PLLA plastics. If orientation is performed at low temperature, the resulting PLLA has enhanced modulus without a significant increase in crystallinity.

PLA can be plasticized using various approaches such as but not exclusive to oligomeric lactic acid (o-LA), citrate ester, or low molecular weight polyethylene glycol (PEG). The effect of plasticization increases the chain mobility and lowers the glass transition temperature to render the PLA less brittle. Other plasticizers may include vitamin-based chemistries such as RIKEMAL PL-710 from Riken Vitamin Company.

An example of a suitable polylactic acid polymer that may be used in the present invention is commercially available from Biomer, Inc. of Krailling, Germany, under the name BIOMER (Registered Trademark) L9000. Other suitable polylactic acid polymers are commercially available from Natureworks LLC of Minnetonka, Minn. (NATUREWORKS (Registered trademark)) or Mitsui Chemical (LACEA (Registered Trademark)). Still other suitable polylactic acids may be described in U.S. Pat. Nos. 4,797,468; 5,470,944; 5,770,682; 5,821,327; 5,880,254; and 6,326,458, which are incorporated herein in their entirety by reference thereto for all purposes.

The polylactic acid typically has a number average 5 molecular weight (“Mn”) ranging from about 40 kDa to about 160 kDa, may be from about 50 kDa to about 140 kDa, and may be from about 80 kDa to about 120 kDa. Likewise, the polymer also typically has a weight average molecular weight (“Mw”) ranging from about 80 kDa to about 200 kDa, may be from about 100 kDa to about 180 kDa, may be from about 110 kDa to about 160 kDa.

The ratio of the weight average molecular weight to the number average molecular weight (“Mw/Mn”), i.e., the “polydispersity index”, is also relatively low. For example, the polydispersity index typically ranges from about 1.0 to about 3.0, may be from about 1.1 to about 2.0, 20 and may be from about 1.2 to about 1.8. The weight and number average molecular weights may be determined by methods known to those skilled in the art.

The polylactic acid may also have an apparent viscosity of from about 50 to about 600 Pascal seconds (Pas), may be from about 100 to about 500 Pas, may be from about 200 to about 400 Pas, as determined at a temperature of 190 deg. C. and a shear rate of 1000 see. The melt flow rate of the polylactic acid (on a dry basis) may also range from about 0.1 to about 40 grams per 10 minutes, may be from about 0.5 to about 20 grams per 10 minutes, may be from about 5 to about 15 grams per 10 minutes, determined at a load of 2160 grams and at 190 deg. C.

Aliphatic biopolymers such as PLA are biodegradable. The main abiotic degradation phenomena involve thermal and hydrolysis degradation. During the composting state, PLA degrades in a multistep process involving different mechanisms. Primarily, after exposure to moisture by abiotic mechanisms, PLA degrades by hydrolysis.

### iv) Examples of Polyhydroxyalkanoate (PHA)

In the present invention, the aliphatic and/or aromatic polyester used can come be from the family of polymers termed as polyhydroxyalkanoates, also known as “PHAs”. These polymers can be synthesized from plant or bacteria fed with a particular substrate, such as glucose, in a fermentation plant. In many instances, the structural or mechanical properties of PHAs can be customized to fit the specifications of the desired end product. PHAs and their copolymers can degrade both aerobically and anaerobically. This makes them particularly well suited for composting or rapidly and completely degrading in the environment.

Such bioplastics are often sold in a form where the plastic is suspended in aqueous emulsions and can be dried into films on various substrates (forming a dispersion coating), although they can also be sold in pellet form for extrusion into films and coatings-which is more relevant for the current invention due to the need to completely contain the liquid formulation. Extruded films are better than dispersion coatings at holding liquid formulations because they tend to contain less pinholes, which reduces the chance of a liquid formulation leaking through the sealant. Coatings formed via dispersion coatings tend to be used more for forming the sealant to contain dry products.

The PHA obtained could be made from a range of various different copolymers. For example, Danimer Scientific, Inc. produces poly(beta-hydroxyalkanoate), poly(3-hydroxybutyrate-co-3-hydroxyhexanoate) NODAX™) and Kaneka produces poly(3-hydroxybutyrate-co-3-hydroxyhexanoate). Non-limiting examples of PHA copolymers include those described in U.S. Pat. No. 5,498,692. Other PHA copolymers can by synthesized by methods known to one skilled in the art, such as, from microorganisms, the ring-opening polymerization of beta-lactones, the dehydration-polycondensation of hydroxyalkanoic acid, and the dealcoholization-polycondensation of the alkyl ether of hydroxyalkanoic acid, as described in Volova, “Polyhydroxy Alkanoates Plastic Materials of the 21” Century: Production, Properties, and Application, Nova Science Publishers, Inc., (2004), incorporated herein by reference.

In the present invention, examples of structural units for forming the PHA resins could include 3-hydroxyalkanoate, which can be represented by the following formula (1):

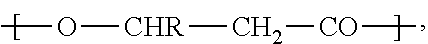

wherein R is an alkyl group represented by CₚH₂ₚ₊₁, wherein p is an integer from 1 to 15, from 1 to 10, and from 1 to 8. Examples of R include linear or branched alkyl groups such as methyl, ethyl, propyl, isopropyl, butyl, isobutyl, t-butyl, pentyl, and hexyl groups.

A group of particularly interesting PHA resins are homopolymers and/or copolymers containing repeating structural units of 3-hydroxybutyrate (hereinafter “P3HB”), either alone or in combination with one or more other repeating structural units.

In the present invention, a blend may be made of at least two P3HB copolymers that contain the same monomeric components or structural units but at different mol %, while at least two P3HB copolymers are provided at specific amounts to form a polymeric resin blend with PHAs as the major part but still with satisfactory processability and mechanical properties.

The P3HB copolymers in the blend could contain 3-hydroxybutyrate repeating structural units (hereinafter “3HB”) in combination with one other type of repeating structural units, e.g., 3-hydroxypropionate, 4-hydroxybutyrate (hereinafter “4HB”), 3-hydroxyvalerate (hereinafter “3HV”), 3-hydroxyhexanoate (hereinafter “3HH”), 3-hydroxyheptanoate, 3-hydroxyoctanoate, 3-hydroxynonanoate, 3-hydroxydecanoate, 3-hydroxyundecanoate, and the like. In the present invention, the PHA copolymers can be poly(3-hydroxybutyrate-co-4-hydroxybutyrate) or poly(3-hydroxybutyrate-co-3-hydroxyhexanoate). More specifically, the PHA copolymers can be poly(3-hydroxybutyrate-co-3-hydroxyhexanoate) containing the same 3HB and 3HH structural units, but at different mol %.

In a specific example, the P3HB copolymers include a first poly(3-hydroxybutyrate-co-3-hydroxyhexanoate) resin comprising a first mol % (i.e., x) of 3HH structural units (hereinafter “P3HB3HHₓ”), and a second poly(3-hydroxybutyrate-co-3-hydroxyhexanoate) resin comprising a second mol % (i.e., y) of 3HH structural units (hereinafter “P3HB3HH_{y}”), while said second mol % is higher than said first mol % (i.e., y>x).

The weight-average molecular weight of the PHA resins used in the present invention is not limited to a particular range. The PHA resins of the present invention may be characterized by a weight-average molecular weight ranging from 100 kDa to 1,000 kDa, or from 200 kDa to 900 kDa, or from 300 kDa to 800 kDa. When the weight-average molecular weight of the PHA resins is below 100 kDa, the mechanical properties of the resins weaken significantly and render them unsatisfactory for forming shaped articles. When the weight-average molecular weight of the PHA resins is above 1,000 kDa, the processibility of the molten form of such resins reduces significantly and renders them difficult to be processed.

The weight-average molecular weight of the PHA resins can be measured as a polystyrene-equivalent molecular weight by gel permeation chromatography (HPLC GPC system manufactured by Shimadzu Corporation) using a chloroform solution of the resin or resin component. The column used in the gel permeation chromatography may be any column suitable for weight-average molecular weight measurement.

The method of producing the PHA resins is not limited to a particular technique. It may be a chemical synthesis production method or a microbial production method. In the present invention, the PHA resins used may be microbially produced. The microbial production method used can be any known method. Non-limiting examples of bacteria that produce P3HB copolymers include Ralstonia eutropha; Aeromonas caviae; Alcaligenes eutrophus, especially that with a P3HH synthase gene introduced. Such a microorganism is cultured under suitable conditions to allow the microorganism to accumulate P3HB3HH in its cells, and the microbial cells accumulating P3HB3HH are used.

Instead of the above microorganism, a genetically modified microorganism having any suitable PHA resin synthesis-related gene introduced may be used depending on the PHA resin to be produced. The culture conditions including the type of the substrate may be optimized depending on the PHA resin to be produced.

Other commercially available examples of PHA resins that can be used in the present invention include PHBV, P3HB4HB, and P3HB available from Ningbo Tianan, Ecomann, and CJ Cheiljedang.

v) Examples of Other Miscellaneous ALIPHATIC and/or AROMATIC POLYESTERS

In the present invention, for aliphatic and/or aromatic polyesters not already mentioned could include polycaprolactones. Poly(e-caprolactone) (PCL) is usually obtained by Ring Opening Polymerization of e-caprolactone in the presence of metal alkoxides (e.g., aluminum isopropoxide, tin octoate). PCL shows a very low Tg (−61° C.) and a low Tm (65° C.), which could be a handicap in some applications. Therefore, PCL is generally blended or modified (e.g., copolymerization, crosslinking). PCL can be hydrolyzed and biodegraded by fungi. PCL can easily be enzymatically degraded. In the present invention, this could also include nylons, for example polyamide-6, or polyamide-6,6. Suppliers of polycaprolactones may include BASF, amongst others.

In the present invention, for aliphatic and/or aromatic polyesters not already mentioned could include polyglycolide or poly(glycolic acid) (PGA) polymers, also spelled as polyglycolic acid. This is a biodegradable, thermoplastic polymer and the simplest linear, aliphatic polyester. It can be prepared starting from glycolic acid by means of polycondensation or ring-opening polymerization. Kureha (USA) is one example of a supplier making PGA polymers.

Poly Propylene Carbonates (PPC)—The present invention may include Poly Propylene Carbonates (PPC) also called poly(propylene carbonate). It is an aliphatic polycarbonate plastic material. The ester group allows the backbone to have molecular flexibility. It is prepared by reacting carbon dioxide and propylene oxide. Suppliers of PPC may include Empower materials, SK energy, Moyomer and Tianguan Group.

### B) Thermoplastic Starches

In the present invention, water insoluble polymers may include specific grades of thermoplastic starches (e.g., MATER-BI from Novamont or PLANTIC® from Plantic/Kuraray, BIOTEC, AGRANA Beteiligungs AG and Grupa Azoty).

Starch is a low cost naturally occurring biopolymer. The starch may be selected from the group comprising natural starch, modified starch, or mixtures thereof. In the present invention, the starch used may be in a native or natural state.

In the present invention, substituted starch may be used. In the present invention, the starch may be destructured during processing to produce thermoplastic starch composition. The thermoplastic starch composition may also comprise a plasticizer.

### C) Heterogeneous Blends of Different Biodegradable Polymers

In the present invention, the biodegradable polymers may be made up of heterogeneous blends of various different biodegradable polymers—since this allows manufacturers to obtain the best balance of properties e.g., balancing biodegradation rates and resistance to the formulations which have direct contact with the biodegradable polymers. One example could include blends of PBAT (e.g., BASF's version marketed under the tradename ECOFLEX®) and PLA (e.g., from Nature Works LLC) which are marketed by BASF under the tradename Ecovio®). PBAT is typically blended with PLA to give more chemical resistance, resistance to hydrolysis or to improve its processability, whilst still balancing the speed of biodegradation and temperature needed for biodegradation to be initiated. Another example of a heterogeneous blend is of PBAT blended with starch which is manufactured by Novamont who market various grades of it under the trade name Materbi. Yet another example of a heterogeneous blend of polymers is PBAT with starch which is manufactured by JinHui ZhaoLong High Technology under the tradename Ecowill. And yet a further example are the blends of PLA and PHA sold by Danimer Scientific, Inc. which are blended together to get the best overall properties of both polymers and often sold under the Nodax brand name. In some cases, soluble biodegradable polymers (as described in a later section) may also be blended in with insoluble polymers.

### D) Additives and Fillers

The biodegradable polymeric layers of the present invention may further comprise one or more additives or fillers.

Contemplated fillers include, but are not limited to, inorganic fillers such as, for example, the oxides of magnesium, aluminum, silicon, and titanium. These materials can be added as inexpensive fillers or processing aides. Other inorganic materials that can function as fillers include hydrous magnesium silicate, titanium dioxide, calcium carbonate, clay, chalk, boron nitride, limestone, diatomaceous earth, mica glass quartz, and ceramics. Additionally, inorganic salts, including alkali metal salts, alkaline earth metal salts, phosphate salts, can be used. Additionally, alkyd resins can also be added to the composition. Alkyd resins can comprise a polyol, a polyacid or anhydride, and/or a fatty acid.

Contemplated nanoparticles could be selected from the group consisting of metals, metal oxides, allotropes of carbon, clays, organically modified clays, sulfates, nitrides, hydroxides, oxy/hydroxides, particulate water in-soluble polymers, silicates, phosphates and carbonates. Specific examples could include silicon dioxide, carbon black, graphite, grapheme, fullerenes, expanded graphite, carbon nanotubes, talc, calcium carbonate, betonite, montmorillonite, kaolin, zinc glycerolate, silica, aluminosilicates, boron nitride, aluminum nitride, barium sulfate, calcium sulfate, antimony oxide, feldspar, mica, nickel, copper, iron, cobalt, steel, gold, silver, platinum, aluminum, wollastonite, aluminum oxide, zirconium oxide, titanium dioxide, cerium oxide, zinc oxide, magnesium oxide, tin oxide, iron oxides (Fe2O3, Fe3O4) and mixtures thereof. Nanoparticles can increase strength, thermal stability, and/or abrasion resistance of the compositions disclosed herein, and can give the compositions electric properties.

In particular aspects, the filler can comprise renewable fillers. These can include, but are not limited to, lipids (e.g., hydrogenated soybean oil, hydrogenated castor oil), cellulosics (e.g., cotton, wood, hemp, paperboard), lignin, bamboo, straw, grass, kenaf, cellulosic fiber, chitin, chitosan, flax, keratin, algae fillers, natural rubber, nanocrystalline starch, nanocrystalline cellulose, collagen, whey, gluten, and combinations thereof. Some of these additives may be biodegradable themselves.

Such one or more additives may be present in an amount ranging from 1 wt % to 40 wt %, or from 2 wt % to 30 wt %, or from 4 wt % to 15 wt %. In the present invention, the biodegradable film may contain little or no such one or more additives.

### E) Other Ingredients

The biodegradable polymeric layers of the present invention may further contain one or more other ingredients, as long as they do not impair the effect of the present invention. Examples of the other ingredients that can be included are: crystal nucleating agents, lubricants, plasticizers, anti-static agents, flame retardants, conductive additives, heat insulators, cross-linkers, antioxidants, ultraviolet absorbers, colorants, inorganic fillers, organic fillers, hydrolysis inhibitors, and the like. Non-limiting examples of crystal nucleating agents for PHA and other polymers include pentaerythritol, orotic acid, aspartame, cyanuric acid, glycine, zinc phenylphosphonate, and boron nitride. Among these, pentaerythritol may be used because it is particularly superior in the accelerating effect on crystallization of the PHA resin component. Non-limiting examples of the lubricants for PHA and other polymers include behenamide, oleamide, erucamide, stearamide, palmitamide, N-stearyl behenamide, N-stearyl erucamide, ethylenebisstearamide, ethylenebisoleamide, ethylenebiserucamide, ethylenebislaurylamide, ethylenebiscapramide, p-phenylenebisstearamide, and a polycondensation product of ethylenediamine, stearic acid, and sebacic acid. Among these, behenamide and erucamide are may be used because they are particularly superior in the lubricating effect on the PHA resin component.

In the present invention, the biodegradable polymeric layers may comprise a surfactant. Suitable surfactants may belong to the non-ionic, cationic, anionic or zwitterionic classes. Surfactants may also include anionic surfactants, amphoteric surfactants, or a combination of anionic and amphoteric surfactants, and combinations thereof, such as surfactants disclosed, for example, in U.S. Pat. Nos. 3,929,678 and 4,259,217, and in EP 414 549, WO93/08876, and WO93/08874. Suitable surfactants could be, but are not limited to, poloxamers (polyoxyethylene polyoxypropylene glycols), alcohol ethoxylates, alkylphenol ethoxylates, tertiary acetylenic glycols and alkanolamides (nonionic), polyoxyethylene amines, quaternary ammonium salts and quaternized polyoxyethylene amines (cationic), and amine oxides, N-alkylbetaines and sulfobetaines (zwitterionic). Other suitable surfactants are dioctyl sodium sulfosuccinate, lactylated fatty acid esters of glycerin and propylene glycol, lactylic esters of fatty acids, sodium alkyl sulfates, polysorbate 20, polysorbate 60, polysorbate 65, polysorbate 80, lecithin, acetylated fatty acid esters of glycerin and propylene glycol, and acetylated esters of 5 fatty acids, and combinations thereof.

The biodegradable polymeric layers according to the present invention may comprise lubricants/release agents. Suitable lubricants/release agents are, but are not limited to, fatty acids and their salts, fatty alcohols, fatty esters, fatty amines, fatty amine acetates and fatty amides. Lubricants/release agents may be fatty acids, fatty acid salts, fatty amine acetates, and mixtures thereof.

The biodegradable polymeric layers according to the present invention may comprise extenders, anti-blocking agents, de-tackifying agents. Suitable extenders, anti-blocking agents, de-tackifying agents are, but are not limited to, starches, modified starches, crosslinked polyvinylpyrrolidone, crosslinked cellulose, microcrystalline cellulose, silica, metallic oxides, calcium carbonate, talc and mica.

The biodegradable polymeric layers may include anti-static agents such as fabric softeners that are known to provide antistatic benefits. These can include those fabric softeners having a fatty acyl group that has an iodine value of greater than 20, such as N,N-di (tallowoyl-oxy-ethyl)-N,N-dimethyl ammonium methylsulfate.

Non-limiting examples of plasticizers for PHA polymers especially include epoxidized soybean oil, glycerin ester compounds, citric ester compounds, sebacic ester compounds, adipic ester compounds, polyether ester compounds, benzoic ester compounds, phthalic ester compounds, isosorbide ester compounds, polycaprolactone compounds, and dibasic ester compounds. Glycerin ester compounds, citric ester compounds, sebacic ester compounds, and dibasic ester compounds may be used in the present invention as providing a plasticizing effect on the polyhydroxyalkanoate resin component. Examples of the glycerin ester compounds include glycerin diacetomonolaurate. Examples of the citric ester compounds include tributyl acetylcitrate. Examples of the sebacic ester compounds include dibutyl sebacate. Examples of the dibasic ester compounds include benzyl methyl diethylene glycol adipate. In addition, epoxidized soybean oil may be used because it is non-toxic and with superior biodegradability.

### F) Cellulosic Polymers Used to Make Cast Cellulose Films

The present invention may utilize a cast cellulose film within the multi-layer structure. These films are made from cellulosic polymers that are biodegradable but that are not thermoplastic and so have to be made into films using a special film solution casting process. One reason for using such a film is when a very good moisture barrier is required, this can be achieved by utilizing a cast cellulose film that has been coated on at least one or both sides. The highest level of barrier is achieved when one side of the cast cellulose film is metallized by coating with a very thin aluminum vapor deposited layer. One example of a supplier of various biodegradable barrier coated cellulose films is Futamura who market such films under their brand name Natureflex™. They are typically placed as an intermediary layer lying between the heat seal layer and any outer layer such as a paper layer. A non-limiting example of such a film is their Natureflex™ NM film which is a metallized cellulose film having a WVTR barrier of approximately 10 g/m2.day at 38 C/90% RH.

### Inorganic Layer that Acts as a Barrier Layer

The addition of an inorganic layer at some point within the layer structure of the biodegradable flexible structure, can act as a barrier layer and provide help in decreasing the water vapor transmission rate (WVTR) of the entire structure. The quality of that layer and how its integrity is maintained is crucial for keeping the good water vapor transmission rate barrier properties of the overall structure. Its interactions with the layers below and above it are important to achieving the best possible barrier properties for the overall structure.

In many cases, the inorganic layer is laid down onto one side of the biodegradable polymeric layer that acts as the sealant layer for the package, via deposition from the vapor phase. In the present invention, the inorganic layer may also or be laid down (also via vapor phase deposition) onto one side of an intermediary biodegradable polymeric layer which is separate to the biodegradable polymeric layer that acts as a sealant for the package. In the present invention it may be also or laid down onto a paper layer via vapor phase deposition—a later section describes more specific details regarding where this may be the case. In yet other cases, the inorganic layer may be laid down onto a paper layer via a “Transfer Metallization Process”. In other cases, inorganic layers may be laid down from an aqueous or other solution using a solution coating process.

### a) Vapor Phase Deposition of an Inorganic Layer

In the present invention, suitable vapor-deposited inorganic coatings may be formed of metals. In the present invention, suitable vapor-deposited inorganic coatings may be formed metal from oxides and related compounds.

The inorganic layer may be optically opaque, translucent or transparent, depending on the specific chemistry applied. Typically, a metal barrier layer such as aluminum would result in an opaque barrier, whereas a metal oxide barrier such as aluminum oxide or silicon dioxide would results in a transparent barrier.

In the present invention, suitable inorganic coatings may be formed by vapor deposition of metals including but not limited to aluminum, magnesium, titanium, tin, indium, silicon, carbon, gold, silver, chromium, zinc, copper, cerium, hafnium, tantalum and diamond-like carbon.

In the present invention, suitable inorganic coatings may be formed by vapor deposition of metal oxides, metal nitrides and related compounds. As used herein, metal oxides include aluminum oxides (e.g., Al₂O₃), aluminum carbide, aluminum nitride, magnesium oxide, titanium oxides (such as titanium dioxide, titanium(3) oxide or titanium monoxide), zinc oxide, tin oxide, yttrium oxide, or zirconium oxides (e.g., zirconium monoxide), calcium oxide, boron oxide or metalloid oxides such as silicon oxides, silicon oxycarbides, and silicon nitrides. Silicon oxide or nitride-based coatings could also be one selected from the group consisting of SiO_{X} (where x is an integer of 1-4) or SiO_{X}N_{Y} (where each of x and y is an integer of 1-3).

In the present invention, the barrier layer may be a single component vapor deposition layer comprising at least one selected from the group above, or a dual component vapor deposition layer comprising at least one combination of two components selected from the group consisting of SiOₓ/Al₂0₃, SiO/ZnO, SiO/CaO, SiO/B₂O₃ and CaO/Ca(OH)₂.

In the present invention, metals and metal oxides can be vapor-deposited using a variety of processes. For example, a metal or metal oxide coating can be vapor-deposited using a chemical vapor deposition process or a physical vapor deposition process. Generally, most chemical vapor deposition processes can be suitable due to the stability of the metal, metal oxides and metal oxide precursors.

In the present invention, a plasma-assisted chemical vapor deposition process can be used to form the vapor-deposited inorganic coating. In the present invention, an atomic layer chemical vapor deposition process can be used.

Plasma-assisted chemical vapor deposition is a modified chemical vapor deposition process in which thermal activation energy is provided by an energetic plasma instead of direct heat. Plasma-assisted chemical vapor deposition processes useful for the films described herein include the steps of vaporizing a metal or metal oxide precursor, introducing plasma to thermally modify the precursor and form intermediate compounds, and cooling the intermediate compounds to form a coating on at least one surface of the structure to be coated. Plasma-assisted chemical vapor deposition processes can be particularly advantageous because such processes can provide the thermal energy necessary for the vapor deposition process without melting, or otherwise damaging, the structure to be coated.

To form metal oxide coatings, various precursor compounds can be vaporized. For example, tetramethylsilane (“TMS”) and trimethylaluminum (“TMA”) can respectively be vaporized to form silicon dioxide (“SiO₂”) and aluminum oxide (“Al₂O₃”) coatings. Hexamethyldisilazane (“HMDS”), hexamethyldisiloxane (“HMDSO”), and tetraethylorthosilicate (“TEOS”) can similarly be vaporized be used to form silicon oxide (“SiOₓ”) coatings.

In the present invention, an atomic layer chemical vapor deposition process may be used to deposit metal oxides or even metals. Atomic layer deposition is a chemical vapor deposition process based on sequential, self-saturating surface reactions. In such processes, the metal oxide precursors are pulsed into a chemical vapor deposition chamber and allowed to build up layer by layer.

In the present invention, a physical vapor deposition process may be utilized. Physical vapor deposition processes differ from chemical vapor deposition processes by instead using physical processes such as heating, or sputtering, to produce vapor from a solid precursor. The vaporized compound adsorbs onto the substrate to be coated, to directly form a thin layer. In the present invention, suitable physical vapor deposition processes to form an inorganic layer may include sputtering, such as magnetron sputtering, thermal evaporation, and electron beam (“e-beam”) evaporation.

In the present invention, physical vapor deposition processes do not require the use of a precursor compound and instead directly vaporize the material of the final coating. For example, an aluminum coating can be formed on the surface of the structure to be coated by sputtering, or e-beam evaporation, of solid aluminum pellets or granules. In the present invention, the inorganic layer coating may be performed by sputtering, ion plating, or via a sol-gel method.

In the present invention, the selection of the specific inorganic coating will depend on the final application. In general, metal oxides are more brittle than metals, whereas metals can be somewhat more elastic than metal oxides. In the present invention, it has been found possible to obtain a lower moisture vapor transmission rate when using aluminum to form the inorganic layer, than if using a silicon oxide. Metal oxide coatings tend to more easily form a plurality of microfractures extending within the inorganic coating than when using metals, which can be detrimental to optimizing the moisture vapor transmission barrier performance and oxygen transmission performance. Some metal oxides form a very transparent inorganic layer, whereas some metals create a very opaque inorganic layer. This may provide a benefit in order to maximize paper recyclability and to minimize any optical defects in the recycled paper—or in order to construct a translucent barrier paper laminate so that the product inside the package can be seen. So, in the present invention, it may include the use a metal oxide barrier coating even if the barrier properties are not as good as achieved via a metal barrier coating.

In the present invention, the top of the biodegradable polymer onto which the inorganic layer will be deposited, can be cleaned using a specific treatment in order maximize the adherence of the inorganic layer to the underlying biodegradable polymer film. For example, a plasma treatment, a solvent treatment, a flame treatment, corona treatment, a photon ablation treatment, an electron beam irradiation treatment, an ion bombardment treatment, an ultraviolet treatment, a vacuum annealing treatment, or a physical abrasion treatment. For example, a helium-oxygen plasma or an argon-oxygen plasma at a flow rate of 30.0 L/min at 100 W to about 150 W of power can be used to ablate the surface of a polymer e layer prior to vapor deposition of an inorganic coating. Other gases can also be used for plasma ablation including nitrogen and ammonia. As can be appreciated, the surface of a primer layer can be partially ablated, substantially fully ablated, or fully ablated in the present invention. Certain ablation processes can also functionalize the surface and provide functional groups for the vapor deposited inorganic coating to adhere to. Certain vapor-deposition processes can obviate the need to use treatment steps. For example, a plasma-assisted chemical vapor deposition process can inherently clean the primer layer and can minimize any need to prepare the primer layer prior to application of the inorganic coating.

In the present invention, two or more physically separated vapor-deposited inorganic coatings can be applied to the structure. In the present invention, the inorganic layer coating could be laid down on top of each other. In the present invention, a primer layer could be used between each of the inorganic layers in order to protect them. Each additional vapor-deposited inorganic coating can be applied similarly to the previously described vapor-deposited inorganic coatings- or they could be applied in a different way.

One graphical representation is shown on page 39 of the fourth edition of the Metallizing Technical Reference published by the Association of Industrial Metallizers Coaters and Laminators and demonstrates the typical apparatus for applying an inorganic layer to a roll of a substrate.

In the present invention, the inorganic layers may have a thickness of 2-1,000 nm, may be from 10-200 nm, and may be from 20-100 nm. In the present invention, the thickness ratio of the inorganic layer to the polymeric layers may be from about 20 to about 20,000.

B) Inorganic Layer Laid Down from an Aqueous Coating

In the present invention, the inorganic layer may be laid down from an aqueous nanocomposite dispersion, onto a suitable layer that will be part of the multilayer structure of the biodegradable flexible packaging. The water is then removed from the aqueous nanocomposite dispersion to obtain a water-dispersible barrier layer. In the present invention, such an inorganic layer may be made from a nanoclay. In the present invention, the inorganic layer laid down from an aqueous coating may be a hectorite clay layer. Additional disclosure for hectorite may be found in U.S. Patent Application Publication No. 2023/0234096 and U.S. Patent Application Publication No. 2023/0235510 incorporated herein by reference. The inorganic layer could also be a Cloisite clay layer. Additional disclosure for Cloisite may be found in U.S. Patent Application Publication No. 20220112664.

In the present invention, the inorganic layer could be laid down on different or multiple surfaces of the biodegradable polymeric layer or other suitable biodegradable substrates.

### Paper Layer

In the present invention, where paper is present in the structure, the paper may be biodegradable without leaving persistent potentially harmful materials in the environment and may be recyclable in typical paper recycling streams. Indeed, papers are typically not made from 100% cellulose fibers only, but will also contain polymeric binders, mineral sizing agents, whitening agents, surfactants and other additives. These other ingredients can be selected appropriately to ensure that (a) the paper will biodegrade to meet certain international biodegradation standards if the package is improperly disposed in the environment and not cause any ecotoxicity issues; and/or (b) the paper will disintegrate in the repulping unit at a paper recycler and release the maximum cellulose fibers for making recycled paper, if the package is recycled; and/or c) the paper will biodegrade in a composting system if the package is sent for composting (home or industrial).

In order for a paper to be considered recyclable, the paper recyclers may obtain at least 50 percent by weight of cellulose fibers from an incoming batch of paper-based waste. For this reason, the package may comprise at least between 50% and 100% by weight of cellulose fibers, may be between 65% and 98% by weight of cellulose fibers, may be between 75% and 95% by weight of cellulose fibers.

It is also contemplated that the paper layer of the present disclosure may itself comprise recycled material (made from either natural or synthetic fibers). For example, any paper present in the structure of the present invention may comprise more than 10% by weight, may comprise more than 20% by weight, may comprise more than 30% by weight of recycled material, specifically reciting all values within these ranges and any ranges created thereby. The paper layer may comprise virgin or recycled paper or mixtures thereof between 0% and 100%.

The presence of recycled material can be made from a visual inspection of the package. For example, manufacturers may advertise the use of recycled materials in an effort to demonstrate their eco-friendly product approach. To further expand on this example, some manufacturers may utilize a logo, e.g., a leaf, along with wording to indicate the use of recycled material in the package material. Often times, manufacturers may specify the percentage of recycled material utilized as well, e.g., over 50 percent, over 70 percent, etc.

Visual inspection can be as simple as utilizing the human eye to inspect packages for logos of the use of recycled material. Visual inspection may include microscopy methods such as optical microscopy, scanning electron microscopy or other suitable methods known in the art. For example, package material comprising recycled paper fibers could look different under a microscope due to the presence of a much wider range of natural fiber types than if the package material comprised 100% non-recycled paper from a single or narrow set of tree or plant types. As another example, under a microscope, potentially scanning electron microscope, recycled fibers, due to their processing may appear more fibrillated than their virgin fiber counterparts.

Non-limiting examples of papers suitable for forming a biodegradable and recyclable paper layer to be part of the present invention include Leine Nature® paper (basis weight=85 g/m²) from Sappi, a machine glazed paper certified “OK Home Compost”; the special kraft paper under brand Lucent from UPM; NiklaSelect V Natural Linen paper (99 g/m²) from Brigl and Bergmeister, a paper sized on one side only; PackPro 7.0 paper (80 g/m²) from Brigl and Bergmeister, a paper sized on both sides; Axello papers from BillerudKorsnäs™ (including from Axello Tough White paper, 80 g/m²) which has been designed to be tougher than many other papers and so which may have some advantages in the distribution chain; and SCG Glassine paper (58 g/m²) from SCG/Prepack. As shown in the TABLE below, these papers pass the paper recycling protocols at both Western Michigan University in the USA and at the PTS Institute in Germany. These papers also pass the OECD 301B biodegradation screening test by undergoing at least 60% biodegradation within 60 days.

| | Western | | |
|---|---|---|---|
| | Michigan Paper | PTS Paper | OECD 301B |
| | Recycling | Recycling | Biodegradation |
| Paper Grade | Protocol | Protocol | Test |
| Leine Nature ® | PASS | PASS | PASS |
| 85 g/m² | | | |
| SappiL | | | |
| NiklaSelect V Natural | PASS | PASS | PASS |
| Linen | | | |
| 100 g/m² | | | |
| Brigl and Bergmeister | | | |
| PackPro 7.0 | PASS | PASS | PASS |
| 80 g/m² | | | |
| Brigl and Bergmeister | | | |
| Axello ® Tough White | PASS | PASS | PASS |
| 80 g/m² | | | |
| BillerudKorsnäs | | | |
| Glassine | NA* | NA* | PASS |
| 58 g/m² | | | |
| SCG Packaging | | | |
| Special Kraft Paper | NA* | NA* | NA* |
| 40, 62, 78 and 90 gsm | | | |
| UPM | | | |

*NA—Not Available

Other suitable papers could include, but are not limited to, paper especially prepared for subsequent decorative metallization, such as Nikkalett Spezial TD paper (60 g/m²) from Brigl and Bergmeister

To withstand the rigors of high-speed manufacturing processes (where products are placed within packages made from laminates disclosed in the present invention) as well as the rigors of shipment, the paper layer may be sufficiently strong and resilient.

The cellulose fibers used to make the paper may be sourced from tree fibers including softwoods and hardwoods and also non-tree fibers which typically have shorter fibers including but not limited to bamboo, grass, hemp, kenaf, flax, corn husks, cotton stalks, coffee grounds, bagasse, rice straw, wheat straw, algae, abaca, sabia grass, esparto grass, milkwood floss fibers, pineapple leaf fibers, wood fibers, pulp fibers and others. Some papers may blend a range of different fibers from different sources.

### Paper Incorporating the Inorganic Layer on One Surface

As mentioned previously, the present invention could include laying down the inorganic layer onto one surface of the paper instead of laying it onto the biodegradable polymeric layer, or onto an intermediary biodegradable polymeric layer.

Three non-limiting examples of how the inorganic layer may be laid down onto paper include: a) Vacuum deposition; and b) Deposition from an aqueous nanocomposite dispersion; and c) In addition, it is possible that the metallized layer is instead transferred to the paper structure from another substrate that has already been metallized. Sometimes this is called a “Transfer Metallization Process”. Information on this has been given herein in the section “Inorganic Layer” and may be referred to.

a) Vapor Phase Deposition onto Paper

In the present invention, it is advantageous that the paper is substantially as flat as possible on at least one side, because this side will need to be coated with additional sizing agents, primers etc. before laying down the inorganic layer. If it is too rough, then the sizing agents and primers and the inorganic layer might be absorbed into the rough paper surface and never actually form a continuous layer. The paper may be flattened as much as possible before adding these additional coatings, via “sizing” during the manufacturing process, which in the industry means that it is typically coated with an aqueous polymeric suspension containing various lower cost inorganic fillers such as clays, calcium carbonate, titanium dioxide, methyl cellulose, silicon dioxide etc. The suspension is then dried, and the paper is calendared to deliver a flatter surface than before sizing, as the inorganic fillers and binders dry down to fill in the porous, rough surface of the paper. In some cases, both sides of the paper are sized—either to the same degree or to different degrees. In the present invention, the paper may be machine glazed during the paper manufacturing process, via a mechanical ironing/pressing step that sometimes involves heat—in this case the paper fibers are squashed together and flattened in order to densify the paper surface and remove porosity. In some cases, sizing and machine glazing are combined to get an even flatter more perfect surface during paper manufacturing, before subsequently being coated with the barrier layers. In other cases, a vellum or glassine or tracing paper might be used because these types of paper are already naturally very flat-such papers are made by a step that during the manufacturing process densifies the paper structure throughout its entire thickness and so further sizing or glazing is not required. The paper layer may also be made via a foam-forming process, a modified paper-making process replacing water by water-based foam.

The degree of flatness of the paper side that is coated with the barrier layers can be measured using 3D LSM. Typically, the degree of roughness (S_{q}—as measured by 3D LSM) may be <1.5 on the side that the barrier layers are coated onto, in order to optimize the barrier properties of all the layers added on top of it as much as possible, especially the inorganic layer if it is deposited via vacuum deposition. The Nikkalett Spezial TD paper which is specifically designed for metallization has a roughness of ~0.98 on the side that is designed to be metallized. However, it is possible that if the inorganic layer is applied via a transfer process such as where a metallized layer is transferred to the paper layer from another pre-metallized substrate, there is possibility that the receiving layer for the transferred metal layer could be of a slightly higher roughness value.

In the present invention, there are some cases when a biodegradable primer layer will be laid down on top of the flattest side of the paper layer, before it is coated with the inorganic layer. The role of the biodegradable primer layer is to flatten the surface of the paper-based layer that will be coated with the primer, yet further and as much as possible, before the inorganic layer is deposited onto it. In general, the lower the roughness value of the paper, the greater the barrier value achieved.

It also needs to be suitable for the inorganic layer to adhere to as well as possible, in order to form a strong interface to enable a stable barrier layer and to avoid delamination of the inorganic layer from the underlying paper layer. In some cases, such a primer layer may be used also (or only) on top of the inorganic layer, to prevent mechanical damage or oxidation and in this case may then be called a protective layer. A primer may also be used to provide additional heat resistance for the thermal hysteresis often experienced during a vapor deposition. A biodegradable primer layer may also sometimes be called a biodegradable lacquer or a biodegradable varnish, in addition to a protective layer. In some cases, if the primer can be coated very thinly, it may even be possible to use non-biodegradable primer, if it is not harmful to the environment. In the present invention, the primer can be an inorganic-organic hybrid-polymer such as bio-ORMOCER® or ORMOCER® developed by The Fraunhofer Institute for Silicate Research in Wurzburg, Germany. These materials are a hybrid between a glass and a polymer, and the exact chemistry of these materials can be tailored to specific applications. Bio-ORMOCER is modified to be biodegradable. Non-limiting examples of ORMOCER® and bio-ORMOCER® include those described in US. Pat. No. 2011/0250441 A1 and U.S. Pat. No. 6,709,757B2, in addition to German patents DE-OS 3828098 and DE4303570.

In the present invention, biodegradable primers versus an inorganic-organic hybrid material could include, but are not limited to, a PVOH lacquer from the Huber Group in Germany or a shellac lacquer. Both these would also be expected to biodegrade. Typically, any primer layer would be laid down in such a way as to give a final cured thickness in the range 0.5-20 μm, range 2-10 μm, and range 1-5 μm. It is important to keep this layer as thin as possible, to keep a good balance between protecting the barrier properties of the inorganic layer—but also to prevent issues in the paper recycling stream. If the primer layer is too thick or too difficult to break up, it may clog up the filters in the paper re-pulping unit or cause optical defects in the resulting recycled paper. Whatever primer is used, eventually the inorganic layer will be laid down on top of it.

B) Indirect Transfer Metallization onto Paper

In the present invention, the metallized layer may not be laid down directly onto a primer layer but instead is transferred to the paper structure from another substrate that has already been metallized. Sometimes this is called a “Transfer Metallization Process”. This is a process often used in the decoration industry, but there are also some applications where the technique is used in forming barrier layers. In this transfer metallization process, the vacuum metallization layer is firstly deposited onto an intermediate substrate, such as a biaxially oriented PET film, or a biaxially oriented PP film, or a cellulose film etc. to form an intermediate structure and later the metal layer is transferred to the paper-based structure. Potential suppliers of these intermediate structures could include Dongguan Ruize Creative Arts New Materials Co., Ltd or Shanghai Zijiang New Material Technology Co., Ltd or others.

The following describes how these intermediate structures can be formed, as they typically contain multiple layers. Before vacuum metallization, the intermediate substrate is coated with a releasing layer, which will have good adhesion to the metallization layer that will be subsequently laid down on top of it—but with relatively worse adhesion to the underlying intermediate substrate. In some cases this releasing layer may be formed from a Polydimethylsiloxane (PDMS) based material, but other chemistries may also be employed. The vacuum metallization can be done using suitable processes aforementioned to deposit a suitable barrier layer. In some cases—but not always, a final primer layer is deposited on top of the metallization layer to protect it until the intermediate structure is used in a transferring process at some later time or date. Such primer coatings may also later be applied to treat the releasing layer with suitable surface energy/tension so that other coating or lamination layers can be applied to it more easily.

In the transferring process, the vacuum metallized intermediate structure is firstly laminated with the paper substrate onto which there is a need to transfer the vacuum metallization layer. Various suitable adhesives are utilized to carry out this transferring process- and the chosen adhesive is first coated onto the paper substrate. The intermediate structure is then brought in contact with the adhesive coated paper substrate in a lamination process using lamination equipment to form a laminated structure. The adhesive forms higher adhesion between the metallized layer and the paper substrate, than the adhesion between the releasing layer and the intermediate substrate in the intermediate structure. The final part of the lamination process causes the laminated structure to be split into two new structures at the weakest interface (which is now the interface between the releasing layer and the intermediate substrate. The two new structures are the final structure (which will be kept for further processing into packaging) and a disposable structure (which is either disposed of, recycled or reused later several times after thorough cleaning). As such, upon separation of the lamination at the weakest interface of the lamination, the vacuum metallization layer is peeled off the original intermediate structure, together with the releasing layer from the intermediate structure and is transferred onto the paper substrate—thus forming the final structure. This final structure then consists of a paper substrate, an adhesive layer, a vacuum metallized layer and a releasing layer.

Later, this final structure will typically undergo yet another lamination process, in order to adhere an extruded biodegradable sealant layer to the releasing layer side. In some cases, an alternative to laminating an extruded biodegradable sealant layer, is to instead directly coat the biodegradable sealant (in the form of fine polymeric particles) onto the final structure via a process such as emulsion coating or dry coating. At the beginning of this lamination process, typically an anchor coating (sometimes based on polyurethane materials, but other materials could be alternatively used) is coated onto the top surface of the releasing layer in order to modify its surface energy ahead of the biodegradable sealant layer being attached to it, to ensure good adhesion between the releasing layer and the biodegradable sealant layer. One example of such a polyurethane material could be the high functional polyurethane dispersion “TAKELAC™ WPB” series of products from Mitsui Chemicals, for example the TAKELAC WPB-341 grade.

### Biodegradable Adhesive Layers

In the present invention, a biodegradable adhesive layer may be used to adhere multiple layers together to form a laminate. Such an adhesive could be either a biodegradable solution-based, solvent-based, or solvent-less adhesive composition. Nonlimiting examples of the biodegradable adhesive layer can include biodegradable polyvinyl acetates, starches, maltodextrins, natural waxes, artificial waxes and polyester-polyurethane blends. In the present invention, the biodegradable adhesive layer may be a commercially available grade from BASF such as Epotal 3675 or Epotal 3702 or Epotal P100ECO (which is a water-based polyester-polyurethane compostable adhesive or Epotal 3702 (also a water-based adhesive), which are all biodegradable and compostable. In the present invention, the adhesive may be BioTAK® by Berkshire Labels; or Bostik 43298 Thermogrip hotmelt adhesive.

In the present invention, a soluble adhesive may have benefits to enhance recyclability in the typical paper repulping system, since it may accelerate the break up of the biodegradable flexible packaging—it may bring similar advantages to the biodegradation process. In other cases, an insoluble adhesive may be used e.g., if moisture levels in the surrounding environment are very high. If a water soluble adhesive is chosen, examples of polymers it could be based on include biodegradable and soluble grades of PVOH and polyethylene oxide. Additional examples of water soluble polymers are also mentioned in the section below called “BIODEGRADABLE POLYMERS THAT ARE WATER-SOLUBLE”. In the present invention, it may be necessary to proceed to lay down an adhesive from a solution in order to minimize the thickness of the adhesive layer. In the present invention, it may be to proceed to lay down an adhesive as a continuous layer in order to obtain maximum bond strength between the layers. In the present invention, it may be considered to lay down the adhesive as a discontinuous layer in order to maximize the speed at which the whole structure can break up during either paper recycling or biodegradation. In some circumstances, it may be deemed acceptable to use a non-biodegradable adhesive if the adhesive is very thin, can safely disperse and if it is based on specific chemistries that will not cause ecotoxicity issues. Potential options include polyurethane based adhesives or ionomer-based adhesives.

Biodegradable Polymers that are Water-Soluble

In the present invention, the material may be in direct contact with the liquid product (the sealant layer), may be insoluble in water; however, in the present invention, a water-soluble polymer may still be used within another part of the biodegradable flexible packaging structure. For example, such a water soluble biodegradable polymeric layer could be suitable to form the lamination or adhesive layer between specific layers within the structure. Copolymers or derivatives thereof suitable for use as a water-soluble polymeric layer are selected from polyvinyl alcohol (PVOH), polyvinyl alcohol copolymers such as butenediol-vinyl alcohol copolymers (BVOH), which are produced by copolymerization of butenediol with vinyl acetate followed by the hydrolysis of vinyl acetate, suitable butenediol monomers being selected from 3,4-diol-1-butene, 3,4-diacyloxy-1-butenes, 3-acyloxy-4-ol-1-butenes, 4-acyloxy-3-ol-1-butenes and the like; polyalkylene oxides, such as polyethylene oxides or polyethylene glycols (PEG); maleic/acrylic acids copolymers; poly(2-acrylamido-2-methyl-1-propanesulfonic acid (polyAMPS); polycarboxylic acids and salts; cellulose derivatives such as cellulose ethers, methylcellulose, hydroxyethyl cellulose, carboxymethylcellulose; hydroxypropyl methylcellulose; natural gums such as xanthan and carrageenan gum; sodium alginates; maltodextrin, low molecular weight dextrin; sugars; polysaccharides; certain thermoplastic starch grades (e.g., specific grades from PLANTIC® from Plantic/Kuraray) polyamino acids or peptides; proteins such as casein and/or caseinate (e.g., such as those commercialized by Lactips).

In the present invention, water-soluble biodegradable polymers may be polyvinyl alcohol, polyethylene oxide, methylcellulose and sodium alginate. For applications where a “plastic free” product is desired, the majority component of the water-soluble polymer layer may be a naturally derived polymer, such as sodium alginate. In the present invention, the level of biodegradable polymer in the water-soluble polymeric layer may be at least 60%. In the present invention, the water-soluble biodegradable polymer may have an average molecular weight (measured by gel permeation chromatography) of about 1 kDa to about 1,000 kDa, or any integer value from about 1 kDa to about 1,000 kDa, or any range formed by any of the preceding values such as about 10 kDa to about 300 kDa, about 20 kDa to about 150 kDa, etc. More specifically for polyvinyl alcohol may have a molecular weight in the range of 30-150 kDa. For polyethylene oxide, the molecular weight may be in the range of 50 kDa to 400 kDa. For methylcelluloses, the molecular weight may be in the range 10 kDa to 100 kDa. The methylcellulose may also be methoxyl substituted from 18% to 32% and hydroxy-propoxyl substituted from 4% to 12%. For sodium alginates, the molecular weight may be in the range from about 10 kDa to about 240 kDa. If homopolymer polyvinyl alcohol is used, the degree of hydrolysis may be in the range 70-100%, or any integer value for percentage between 70% and 100%, or 84% and 92% or 86% and 90% or any range formed by any of these values, such as 80-100%, 85-100%, 90-100%, 95-100%, 98-100%, 99-100%, 85-99%, 90-99%, 95-99%, 98-99%, 80-98%, 85-98%, 90-98%, 95-98%, 80-95%, 85-95%, 90-95%, etc. Certain grades of polyvinyl alcohol may claim to have greater resistance against moisture, whilst still being soluble. Examples include the Exceval range of polyvinyl alcohol from Kuraray, including the grades Exceval HR-3010 and Exceval AQ-4104.

Water-soluble polymers can be processed via thermal extrusion and via solution casting. Solution casting is directed to the water-soluble polymer to first be formed into a polymer solution. A polymer that is in solution can be said to be water-borne. In the present invention, a water-borne polymer may be used because a thinner and flatter, more uniform biodegradable polymeric layer can be formed than if it is extrusion coated. In the present invention, water soluble polymer coating may be used as the lamination layer between various other layers. The water-soluble polymereric layers may contain disintegrants, plasticizers, surfactants, lubricants/release agents, fillers, extenders, antiblocking agents, detackifying agents, antifoams, or other functional ingredients. In the present invention it may be for certain applications that the polymeric layers that are water-soluble contain disintegrants to increase their dissolution rate in water. Suitable disintegrants are, but are not limited to, corn/potato starch, methyl celluloses, mineral clay powders, croscarmellose (cross-linked cellulose), crospovidone (cross-linked polyvinyl N-pyrrolidone, or PVP), sodium starch glycolate (cross-linked starch). In the present invention, the water-soluble polymeric layers may comprise between 0.1% and 15%, may be from about 1% to about 15% by weight of disintegrants.

In the present invention, the biodegradable polymeric layers that are water-soluble may contain water-soluble plasticizers. The water-soluble plasticizer may be selected from polyols, sugar alcohols, and mixtures thereof. Suitable polyols include polyols selected from the group consisting of glycerin, diglycerol, ethylene glycol, diethylene glycol, triethylene glycol, tetraethylene glycol, polyethylene glycols up to 400 Da molecular weight, neopentyl glycol, 1,2-propylene glycol, 1,3-propanediol, dipropylene glycol, polypropylene glycol, 2-methyl-1,3-propanediol, methylene glycol, trimethylolpropane, hexylene glycol, neopentyl glycol, and polyether polyols, or a mixture thereof. Suitable sugar alcohols include sugar alcohols selected from the group consisting of isomalt, maltitol, sorbitol, xylitol, erythritol, adonitol, dulcitol, pentaerythritol and mannitol, or a mixture thereof. In some cases, the plasticizer could be selected from the following list: ethanolamine, alkyl citrate, isosorbide, pentaerythritol, glucosamine, N-methylglucamine or sodium cumene sulfonate. Less mobile plasticizers such as sorbitol or polyethylene oxide can facilitate the formation of water-soluble polymeric layers with greater barrier properties than water-soluble polymeric layers including a more mobile plasticizer such as glycerin. In some circumstances when there is a desire to use as many naturally derived materials as possible, the following plasticizers could also be used: vegetable oil, polysorbitol, dimethicone, mineral oil, paraffin, C₁-C₃ alcohols, dimethyl sulfoxide, N, N-dimethylacetamide, sucrose, corn syrup, fructose, dioctyl sodium-sulfosuccinate, triethyl citrate, tributyl citrate, 1,2-propylene glycol, mono, di- or triacetates of glycerin, natural gums, citrates, and mixtures thereof. The water-soluble plasticizers may be selected from glycerin, 1,2-propanediol, 20 dipropylene glycol, 2-methyl-1,3-propanediol, trimethylolpropane, triethylene glycol, polyethylene glycol, sorbitol, or a mixture thereof, may be selected from glycerin, sorbitol, trimethylolpropane, dipropylene glycol, and mixtures thereof. The water-soluble polymeric layers may comprise between 5% and 50%, may comprise between 10% and 40%, may comprise from about 12% to about 30% by weight of plasticizers.

In the present invention, the biodegradable polymeric layers that are water-soluble may comprise a surfactant. Suitable surfactants may belong to the non-ionic, cationic, anionic or zwitterionic classes. Suitable surfactants are, but are not limited to, poloxamers (polyoxyethylene polyoxypropylene glycols), alcohol ethoxylates, alkylphenol ethoxylates, tertiary acetylenic glycols and alkanolamides (nonionic), polyoxyethylene amines, quaternary ammonium salts and quaternized polyoxyethylene amines (cationic), and amine oxides, N-alkylbetaines and sulfobetaines (zwitterionic). Other suitable surfactants are dioctyl sodium sulfosuccinate, lactylated fatty acid esters of glycerin and propylene glycol, lactylic esters of fatty acids, sodium alkyl sulfates, polysorbate 20, polysorbate 60, polysorbate 65, polysorbate 80, lecithin, acetylated fatty acid esters of glycerin and propylene glycol, and acetylated esters of 5 fatty acids, and combinations thereof. The water-soluble polymeric layers may comprise between 0.1% and 2.5% by weight of surfactants; may comprise from about 1% to about 2% by weight of surfactants.

In the present invention, the biodegradable polymeric layers that are water soluble may comprise lubricants/release agents. Suitable lubricants/release agents are, but are not limited to, fatty acids and their salts, fatty alcohols, fatty esters, fatty amines, fatty amine acetates and fatty amides. in the present invention, lubricants/release agents may be fatty acids, fatty acid salts, fatty amine acetates, and mixtures thereof. In the present invention, the water-soluble polymeric layers comprise between 0.02% to 1.5%, may comprise from about 0.1% to about 1% by weight of lubricants/release agents.

In the present invention, the biodegradable polymeric layers that are water soluble may comprise fillers, extenders, anti-blocking agents, de-tackifying agents. Suitable fillers, extenders, anti-blocking agents, de-tackifying agents are, but are not limited to, starches, modified starches, crosslinked polyvinylpyrrolidone, crosslinked cellulose, microcrystalline cellulose, silica, metallic oxides, calcium carbonate, talc and mica. In the present invention, the biodegradable polymeric layers may comprise between 0.1% to 25%, may comprise from about 1% to about 15% by weight of fillers, extenders, anti-blocking agents, de-tackifying agents. In absence of starch, the biodegradable polymeric layers may comprise between 1% to 5% by weight of fillers, extenders, anti-blocking agents.

In the present invention, the water-borne biodegradable polymeric layers that are water-soluble may comprise antifoams. Suitable antifoams are, but are not limited to, polydimethylsiloxanes and hydrocarbon blends. In the present invention, the water-soluble polymeric layers may comprise between 0.001% and 0.5%, may comprise from about 0.01% to about 0.1% by weight of antifoams.

Biodegradable flexible packaging where at least one of the biodegradable polymeric layers is made from a water-soluble polymer according to the present invention may contain residual moisture in the water-soluble layer depending on the hygroscopy and the isotherm of the laminate components at given temperature and humidity conditions measured by Karl Fischer titration. For example, water-soluble polyvinyl-alcohol layers in the laminate may contain about 4-8% residual moisture at 23° C. and 50% r.H.

### INKS, BRANDING and DECORATION

The biodegradable flexible packaging according to the present invention may be opaque in most cases but could be translucent in a few cases when a specific selection of materials is made. The biodegradable flexible packaging according to the present invention may comprise a printed area. Printing may be achieved using standard printing techniques, such as flexographic, gravure, offset lithography, or inkjet printing. The biodegradable flexible packaging according to the present invention may be arranged as a package in a myriad of configurations. For example, the package may comprise a plurality of panels which enclose a plurality of articles. Each of these panels comprises an inner surface and an outer surface. The outer surface and/or inner surface of one or more panels may comprise ink or dyes which create branding on the package, package information, and/or background color, etc.

In the present invention, the ink that is deposited can be either solvent-based or water-based and the pigments within the ink may be either organic or inorganic, or a combination of both. In the present invention, the ink is highly abrasion resistant. For example, the high abrasion resistant ink can include coatings cured by ultraviolet radiation (UV) or electron beams (EB), or coatings including nitro cellulose and cured during solvent evaporation. In the present invention, any organic pigments within the ink are derived from a petroleum source. In the present invention, any organic pigments within the ink may be derived from a renewable resource, such as soy, a plant. In the present invention, any organic pigments within the ink may also be biodegradable if the pigment is organic and designed to biodegrade. In the present invention, any inorganic pigments within the ink will be made from an inorganic metal oxide that is safely dispersible and not harmful to the environment at the levels used, even if itself is not biodegradable.

Non-limiting examples of inks that are not biodegradable but do not inhibit biodegradation and can safely disperse during biodegradation include ECO-SUREI™ from Gans Ink and Supply Co. and the solvent based VUTEK® and BioVu™ inks from EFI, which are derived completely from renewable resources (e.g., corn). Others include SunVisto AquaGreen, Aquathene from Sun Chemicals; and also INXhrc™ and GENESIS™ GS from Sakata Inx. A biodegradable ink may for example be made from a regenerated vegetable oil ink, soybean oil ink and the like. The soybean oil ink is obtained by replacing all or a part of a petroleum-based solvent and a drying oil in a conventional ink with a soybean oil, and is advantageous since it allows the ink to be readily separated from the paper and to be degraded in a soil. The soybean oil ink may be available commercially for example from TOYO INK MFG. CO., LTD. or TOPPAN PRINTING CO., LTD. Another potential biodegradable ink is and Blue Iris from Sun Chemicals. Whatever type of ink is used, the ink is typically present in a thickness of about 0.5 μm to about 20 μm, may be from about 1 μm to about 10 μm, may be from about 2.5 μm to about 3.5 μm. The biodegradable flexible packaging of the present invention may comprise inks and/or dyes to provide a background color to the packages of the present disclosure. In order to reduce the use of inks/dyes for the benefit of the recycling process, the natural color of the paper layer may be utilized. For example, inks/dyes may be used to define the background color of the consumer-facing panel only, whereas the natural color of the paper layer would be used as background color for the other panels of the flexible package.

### Surface Coating for Ink Protection

In the present invention, the printed surface of the biodegradable flexible structure used to make the packaging is surface coated to protect the ink layer from its physical and chemical environment, to increase the durability of the paper layer and to provide a glossy or matte finish. This surface coating may be called a lacquer or a varnish or a splash-resistant layer. In the present invention, non-limiting examples the surface coating may be made from a nitrocellulose lacquer, an acrylic lacquer, a water-based lacquer, or a reactive two-components polyurethane lacquer. Biodegradable options may be used to enhance the overall biodegradation of the overall package. In the present invention, the surface coating may include those made from natural waxes passing the OECD301B biodegradation screening test, such as bees wax, rapeseed wax, castor wax, candelilla wax, soy wax, palm oil wax or another natural wax, provided that the temperature of exposure is not exceeding the wax melting point. In some cases, some paraffin oil-based waxes may also pass OECD301B. Because the thickness of the surface coating affects the recyclability and the biodegradation of the package made from the recyclable barrier paper laminate of the present invention, thinner surface coatings may be used. The thickness of the surface coating is between 0.1 μm to 25 μm, is below 10 μm, is below 5 μm. In some cases, the surface coating may further enhance the WVTR of the overall package.

Biodegradable Polymeric Films and/or Heat Sealant Layer Method of Making

The biodegradable flexible structures used to produce the packages and articles of the present invention can be processed using conventional procedures for producing multilayer films on conventional coextruded film making equipment. See, e.g., U.S. Pat. Nos. 5,391,423 and 5,939,467, which are each incorporated herein by reference. In general, polymers can be processed into films using either cast or blown film extrusion methods. See, e.g., Griff, “Plastics Extrusion Technology,” 2” Ed., Van Nostrand Reinhold, 1976, which is incorporated herein by reference. Cast film is extruded through a linear slot die. Generally, the flat web is cooled on a large, moving polished metal roll. The film peels off this first roll, passes over one or more auxiliary cooling rolls, through a set of rubber-coated pull or “haul-off” rolls, and then to a winder. In blown film extrusion, the melt is extruded upward through a thin annular die opening, a process referred to as tubular film extrusion. Air is introduced through the center of the die to inflate the tube, which causes it to expand. A moving bubble results, which is maintained at a constant size by controlling the internal air pressure. The tube of the film is cooled by blowing air through one or more chill rings surrounding the tube. The tube is then collapsed by drawing it into a fattening frame through a pair of pull rolls and into a winder. Both cast film and blown film processes can be used to produce either monolayer or multilayer film structures. The production of monolayer films from a single thermoplastic material or blend of thermoplastic components requires only a single extruder and single manifold die. If a particular film requires a blend (e.g., sealant/barrier material, sealant/filler), pellets of the components first can be dry blended and then melt mixed in the extruder feeding that layer. In the present invention, if insufficient mixing occurs in the extruder, the pellets can be first dry blended and then melt mixed in a pre-compounding extruder, followed by repelletization prior to film extrusion. In some cases, the biodegradable polymeric layer may be formed by directly extruding onto other layers, either by thermal extrusion or in some cases applied as a polymeric suspension that is then cured into a continuous layer.

Coextrusion processes are employed for the production of multilayer films. Such processes require more than one extruder and either a coextrusion feedblock or multi-manifold die system, or combination of the two, to achieve the multilayer film structure. The feedblock principle of coextrusion is described in U.S. Pat. Nos. 4,152,387, and 4,197,069, each incorporated herein by reference. Multiple extruders are connected to the feedblock, which employs moveable flow dividers to proportionally change the geometry of each individual flow channel in direct relation to the volume of polymer passing through the flow channels. The flow channels are designed such that the materials flow together at the same flow rate and pressure at their point of confluence, eliminating interfacial stress and flow instabilities. After the materials are joined in the feedblock, they flow into a single manifold die as a composite structure. The melt viscosities and melt temperatures of the materials should not differ too greatly; otherwise flow instabilities can result in the die leading to poor control of layer thickness distribution in the multilayer film, as described in U.S. Pat. No. 5,498,692. In the present invention, rather than the feedblock coextrusion, there may be used a multi-manifold or vane die as disclosed in aforementioned U.S. Pat. Nos. 4,152,387, 4,197,069, and in US. Pat. No. 4,533,30, incorporated herein by reference. In the present invention, various layers may be microlayered using various technologies. In microlayering, the interfacial properties dominate due to the small dimension of the layer thicknesses. Microlayering systems from Nordson/EDI or Cloeren are exemplary processes for completing the microlayering.

In some instances, particularly for biodegradable polymers like polylactic acid (PLA), it is more common to form a film via a different process called biaxial orientation. This requires different equipment to standard extrusion. Films produced via this method tend to be stiffer which can enable them to be better structures for subsequent coating by an inorganic layer designed to act as a barrier layer.

In some other instances, it is possible that the sealant layer may not be formed from an extruded film, but rather by coating the rest of the substrate with fine polymeric particles. These could be applied either as an emulsion of the fine polymeric particles, or the particles could be applied as a dry powder. The size of these particles is typically in the range about 0.1 μm to about 1000 μm; from about 1 μm to about 100 μm, but could potentially be outside this range. Whichever form the fine polymeric particles are applied in, it is then necessary to perform a heating step in which the fine polymeric particles are melted to form a continuous layer to contain whatever product will be held within the package.

### Lamination of Multiple Different Layers to Form a Laminate

In the present invention, the biodegradable flexible structure used to make the package may be constructed from several layers of different types of material that need to be bound together to form one multilayer laminate structure, that can then be formed into a package. Although some of the polymeric layers may be produced by the methods described in the section above “BIODEGRADABLE POLYMERIC FILMS METHOD OF MAKING”, some layers might be paper (with a barrier or not) or even polymeric layers that have been precoated with some type of barrier. The separate layers that make up the package may be laminated together to form a multilayer laminate structure. In the present invention, any adhesives used for lamination may be biodegradable and are mentioned in the section called “BIODEGRADABLE ADHESIVE LAYERS”. Laminating is the process through which two or more flexible packaging webs are joined together using a bonding agent. The substrates making up the webs may consist of films, papers, or aluminum foils. In general terms an adhesive is applied to the less absorbent substrate web, after which the second web is pressed against it to produce a duplex, or two-layer, laminate. Some types of lamination technique may include, not limited to wet lamination, dry lamination, wax lamination and solventless lamination. Other types of lamination could include various forms of thermal lamination including thermal lamination, conventional thermal lamination, extrusion lamination and extrusion coating lamination.

### Sachet Method of Making

The laminate structures that are produced by the aforementioned processes can be converted into the packages and articles of the invention using a form-fill-seal process. A traditional process typically involves three successive steps where the package or article is formed from the film structure, filled, and then sealed or closed, as described in U.S. Pat. No. 6,293,402, which is incorporated herein by reference. In heat sealing methods, a temperature range exists above which the seal would be burnt, and below which the seal would not be sufficiently strong. Seals are provided by any sealing means known to one skilled in the art. Sealing can comprise the application of a continuously heated element to the film, and then removing the element after sealing. The heating element can be a hot bar that includes jaws or heated wheels that rotate. Different seal types include fin seals and overlap seals. Single Lane Process a well-known sealing single lane process using a vertical form and fill machine is described in U.S. Pat. No. 4,521,437, incorporated herein by reference.

### Multilane Process

The packages of the invention can also be processed using a multilane sachet packaging machine, such as the VEGA PACK 300S by QuadroPack. A high-speed, multi-lane sachet processing machine is also described in U.S. Pat. No. 6,966,166, incorporated herein by reference. Other non-limiting types of sachet machine could include the following—Shubham and/or Hassia sachet machines and/or Arjunior high speed sachet machines as disclosed in U.S. Pat. No. 9,809,336 herein incorporated by reference.

### Final Form of the Biodegradable Flexible Sachet or Package

The sachet or flexible package of the present invention can be a block bottom bag, a flat bag, a flowpack, a cross-bottom bag, a side gusset bags, a three-sided side sealed bag, a four-sided side sealed bag, a stand-up pouch, a stick pack, or a fully contoured pouch. The sachets can be connected and can be sold to stores, including high frequency stores, as a roll with a plurality of sachets that are connected end to end with perforations in between each sachet so the consumer can choose how many sachets she wants to purchase and tear them off the roll. In some non-limiting examples, the perforations can be a zig-zag where the zig-zag makes it easier for the user to open the sachet. A roll of sachets can also have multiple sachets across that are separated by perforations (i.e., a multi-lane sachet with two, three, four, or more lanes). The sachet can have a pictorial usage instruction printed on at least one surface.

### Liquid Food Composition

The liquid food compositions of the present invention may include, but are not limited to, products such as honey, fruit spread, fruit sauce, peanut butter, ketchup, mayonnaise, mustard, applesauce, hot sauce, jams, marmalades, sandwich spreads, sauces, salad dressings, seasonings, syrups, jellies, and other condiments and edible liquid food compositions, and all combinations thereof.

In some embodiments, the liquid food composition may be in a single use package, in an amount from about 4 to about 12 grams, or from about 0.25 ounces to about 2.0 ounces, or from about 5 ml to about 10 ml.

### Humectant

The present invention may comprise a humectant. Humectants have an affinity to hydrogen bonds of water molecules.

Edible humectants could include glycerin, which is preferred for use as a humectant in the present invention. However, many other substances can substitute for glycerin in the compositions of the invention. Substances that have been found to be suitable include, but are not limited to, erythritol, 1,2-propanediol (any isomer), ethanol and sorbitol. Other substances that are suitable include, but are not limited to: threitol; dihydroxyacetone; 1,3-propandiol (any isomer); 1,2,3-butanetriol (any isomer); 1,2,4 butanetriol (any isomer); 1,2 butanediol (any isomer); 2,3 butanediol (any isomer); arabitol; xylitol; ribitol; mannitol; galactitol; fucitol; iditol; inositol; volemitol; isomalt; maltitol; lactitol; maltotriitol; maltotetraitol; polyglycitol; polyethylene glycol (PEG) (all chains lengths) and non-toxic PEG derivatives including methoxy polyethylene glycols; sugar alcohols; all other non-toxic diols or triols preferably with low melting point; hydrogenated sugars or sugar derivatives including hydrogenated starches; non-toxic aminoalcohols preferably with low melting point; and all related diols and triols derivatives including esters, ketone or aldehydic derivatives, e.g., ethyl 2,3-dihydroxypropanoate. Others could include corn syrup solids, glycerin, lactic acid, PEGs, propylene glycol, sodium lactate, sorbitol, trehalose, and xylitol. For ease of reference, the formulations typically are disclosed with reference to glycerin as the humectant; however, one or more, or combinations of, the above-listed humectants can be used in place of glycerin.

The composition contains a safe and effective amount of the humectant. In particular, it may contain from about 0% to about 50%, from about 20% to about 50%, or from about 23% to about 45%, by weight of a humectant.

In the present invention, the composition may contain two or more different humectants, for example, the composition may contain glycerin and xylitol.

### Thickening Polymers

The liquid food composition may comprise a thickening polymer to increase the viscosity of the composition. Suitable thickening polymers can be used. The liquid food composition may comprise from about 0.05% to about 10% of a thickening polymer, from about 0.05% to about 5% of a thickening polymer, from about 0.05% to about 2.5% % of a thickening polymer, and from about 0.05% to about 2% of a thickening polymer.

Food thickeners are mostly obtained from different natural raw material sources which include land, marine plants, microorganisms, and animal connective tissues. They can be classified into four broad categories: gum based, protein based, plant based, and microbe based. Protein sources of food thickening agents could include whey protein & soy protein. Plant-based food thickeners could include moringa seeds, alyssum seeds, jackfruit seeds, tomato pomace, corn starch, rice flour & tapioca starch. Gum-based food thickeners could include guar gum & xanthan gum. Microbe-based thickeners could include micro algae, bacterial cellulose and salecan.

Other thickening polymer modifiers may include a polyacrylate, polyacrylamide thickeners. The thickening polymer may be an anionic thickening polymer.

### Other Ingredients:

Other ingredients could include oils (e.g., soy bean oil, olive oil, butter, milk fat or others); vinegars (e.g., white wine vinegar or distilled vinegar); sugars and syrups (e.g., sugar, honey, fructose, corn syrup, high fructose corn syrup); egg (e.g., egg whites, yolks, whole egg, egg yolk solids); fruit juices (e.g., lemon, orange, strawberry, lime, concord grape); fruit concentrates (e.g., strawberry); flavor protectants (e.g., calcium disodium EDTA); flavors (including natural and synthetic e.g., salt, spice, onion powder, chili, garlic); fruit or vegetable concentrates (e.g., tomato concentrate); fiber (e.g., pectin); gums (e.g., xanthan gum) citric acid; preservatives (e.g., potassium sorbate, sodium bisulfite) or other ingredients.

The liquid food compositions typically have viscosity ranges from 0.001 PaS to 1000 PaS, or from about 2000 to about 200,000 cps, or in some embodiments, from about 2000 to about 100,000 cps. The liquid food compositions may have a pH range from 3.5 to 7.

The liquid food compositions of the present invention may have from about 0 to 50%, 14% to about 50% water; may have from about 35% to about 50% water.

### Test Methods for Formulation

### Water Activity

In the present invention, water activity is either measured in Aw (when on a scale of 0-1) or relative humidity-% RH when it is reported as a percentage RH %=aw*100. The water activity (Aw) of the liquid food composition is the ratio between the vapor pressure of the liquid food composition itself, when in a undisturbed balance with the surrounding air media, and the vapor pressure of distilled water under identical conditions.

### Water Activity Determination

In the present invention, equipment that may be used for Water Activity Determination may be: A) Hygrolab C-1 water activity meter, equipped with temperature and humidity probe (Available from Rotronic AG) and B) Shallow, disposable sample cup (Available from Rotronic AG). In the present invention, the water activity of the test materials may be determined by using a temperature and humidity probe and a Hygrolab C-1 meter (available from Rotronic AG) A disposable sample cup (available from Rotronic AG) is filled with test material, lowered into the sample holder, and covered by the humidity and temperature probe. Using the meter's AwE mode, the water activity of the equilibrated product will be displayed on the meter as water activity (Aw). The following conversion factor can be used to switch between units: 1.000 Aw=100% RH. Viscosity Method.

The present invention may have a Water Activity (Aw) of from about 0.40 to about 0.90; may have a Water Activity (AW) of from about 0.80 to about 0.87. The present invention may have a Water Activity (Aw) that is below from about 0.80.

### Viscosity Determination

In the present invention, equipment and instrumentation that may be used for viscosity determination are: A) Disposable syringe (Available from VWR); Rheometer (Available from TA Instruments) and C) 40 mm parallel steel plates (Available from TA Instruments). In the present invention, the viscosity of the liquid food test materials may be determined by using a Discovery DHR rheometer from TA instruments (New Castle, Delaware, USA). Data collection, processing, and reporting are executed using TRIOS software, version 5.1.1.46572 (available from TA Instruments). The instrument is configured using a 40 mm diameter parallel steel plate, a gap size of 1000 μm, and a temperature of 25° C. The data is collected using a flow peak hold at a shear rate of 2.0 s⁻¹ with a duration of 180 seconds, and the reported viscosity is the value measured at 180 seconds. In the present invention, the liquid food composition may have a viscosity of from about 5,000 cps to about 20,000 cps; from about 8,000 cps to about 14,000 cps; from about 7,000 cps to about 12,000 cps.

### Percent Weight Loss Determination

In the present invention, equipment that may be used for percent weight loss determination are: A) Controlled temperature and humidity (CTCH) chamber/room; B) Analytical balance with a sensitivity of 0.1 mg (available from Mettler Toledo); C) Fiberglass cafeteria trays (available from Amazon) and D) Spreadsheet Processor (available from Microsoft). In the present invention, the percent weight loss may be determined wherein sachets may be filled with product test material and sealed. Their initial weight is collected using an AT200 analytical balance (available from Mettler Toledo) and then recorded into an Excel spreadsheet (available from Microsoft). The sachets are placed on a cafeteria tray (available from Amazon) and stored in a controlled temperature and humidity (CTCH) room set to desired temperature and humidity instead. Sachets are weighed at chosen time intervals and weight loss over time is recorded.

### Calculation

$$\% Weight Loss = \frac{Delta Weight}{Initial Weight} \times 100. \qquad 1$$

$$Where Delta Weight = Weight - Initial Weight$$

### EXAMPLE

| Sample ID | Initial Weight | Weight @ 1 Week | Delta Wt | % wt loss |
|---|---|---|---|---|
| Sample A | 14.4187 | 14.3694 | 0.0493 | 0.342% |

### Test Methods for Packaging

In the present invention, when testing and/or measuring a material, if the relevant test method does not specify a particular temperature, then the test and/or measure is performed on specimens at 23° C. (±3° C.), with such specimens preconditioned at that temperature. When testing and/or measuring a material, if the relevant test method does not specify a particular humidity, then the test and/or measure is performed on specimens at 35% (±5%), with such specimens preconditioned at that humidity. Testing and/or measuring should be conducted by trained, skilled, and experienced personnel, according to good laboratory practices, via properly calibrated equipment and/or instruments.

1) Biodegradation screening test OECD 301B—The major components (e.g., paper and sealant) may be tested separately and then the final package, should all be tested for biodegradation according to the test method OECD 301B. The final package includes all major and minor (e.g., adhesives, primers, barriers, inks, varnishes) components and is open at one end to mimic its disposal after being opened by a consumer. Pass/fail success criteria are shown in TABLE below:

### OECD Biodegradation Test Methods and Pass Criteria

| Test Method | Pass Criteria |
|---|---|
| OECD 301B | 60% thCO₂ evolution or thO₂ |
| Test major components in each layer | consumption in 60 days |
| Test fully formed sachet* | |

The sample should biodegrade at least 60% within 60 days.

Aerobic biodegradation is measured by the production of carbon dioxide (C02) from the test material in the standard test method as defined by Method 301B test guidelines of the Organization for Economic Cooperation and Development (OECD) the test is run per the indicated OECD test protocols except that it is conducted for 60 days. The polymers may achieve at least 60% of biodegradation as measured by C02 production in 60 days in the standard Method 301B. These OECD test method guidelines are well known in the art and cited herein as a reference {OECD (1992) Test No. 306: Biodegradability in Seawater, OECD Guidelines for the Testing of Chemicals, Section 3, OECD Publishing, Paris, https://doi.org/10.1787/9789264070486-en. and OECD (1992), Test No. 301: Ready Biodegradability, OECD Guidelines for the Testing of Chemicals, Section 3, OECD Publishing, Paris, https://doi.org/10.1787/9789264070349-en.}.

2) OK compost INDUSTRIAL (EN 13432) Test-Packaging or products featuring the OK compost INDUSTRIAL label are guaranteed as biodegradable in an industrial composting plant. When testing is conducted, the package includes all components, inks and additives. The sole reference point for the certification program is the harmonized EN 13432:2000 standard: in any event any product featuring the OK compost INDUSTRIAL logo should comply with the requirements of the EU Packaging Directive (94/62/EEC). One test is a test for disintegration. To pass the disintegration test, the package must disintegrate by 90% within 12 weeks, with any remaining pieces being able to pass through a 2 mm sieve. The temperature must not be raised above 75 C and after 1 week the temperature must be reduced to 50 C. This is intended to simulate what would happen inside an actual industrial composting unit.
3) OK compost HOME Test-Owing to the comparatively smaller volume of waste involved, the temperature in a garden compost heap is clearly lower and less constant than in an industrial composting environment. This is why composting in the garden is a more difficult, slower-paced process. TÜV AUSTRIA's developed OK compost HOME to guarantee complete biodegradability in the light of specific requirements, even in a garden compost heap. OK compost HOME is not based on a standard but is the basis for several standards. It seems important to remember that the OK compost HOME certification program does not explicitly refer to a specific standard but details all the technical requirements that a product must meet in order to obtain the certification. The disintegration test involves ensuring that disintegration occurs within 6 months at a temperature no higher than 30 C. This is intended to simulate what would happen inside an actual home compost.

In some cases, we may utilize other composting tests that follow similar testing requirements to the OK compost HOME test such as the Australian Standard AS 5810—2010 for Biodegradable plastics—Biodegradable plastics suitable for home composting. The test is run at 25 C and samples are expected to reach 90% biodegradation within 12 months, when using the test to predict the ability of a material to break down in home composting conditions. The test can also be used to predict the ability of a material to break down in Industrial Composting conditions, in which case the material is expected to reach 90% biodegradation within 6 months when run at 58 C.

4) “Aerobic biodegradation test in marine sediment” test—This test is carried out according to ISO23832 in order to understand the behaviour of product materials in the marine environment. Since most biodegradable materials are more dense than water, it is expected that such materials will eventually sink in the ocean and lay on top of the sediment at the bottom of the sea and eventually sink into the sediment such that it is buried. Therefore it is often most relevant to perform this test by using sediment collected from the sea. Since the majority of locations in which the invention will be utilized are in warm tropical environments, it is most relevant to perform this test at a temperature of 25 C. In this invention, we chose to select materials that reach at least 50% biodegradation in 150 days when placed in biodegradation testing according to ISO23832 at 25 C. This test is performed while the sample is buried in the sediment.

For the test methods for biodegradation listed above in this section, the packaging films can be tested either with or without being exposed to the products or formulas to be packed in the package using such films, before they undergo biodegradation. The exposure could be just on one side of the film, such as with product filled in an enclosed compartment made from the package film, or with both sides of the film, such as when immersing the package film in the product or formula. The exposure is normally conducted under an accelerated test setup, i.e., under 40 degree C. or 50 degree C. for duration less than desired shelf life. It could also be under ambient test setup, i.e., 25 degree C. or 30 degree C. for duration representing an averaged or reasonable shelf life. As the product may impact the film through hydrolysis or other interacting mechanisms, the exposure could prepare the packaging film to better represent the biodegradation profile when disposed at the end of the lifecycle-since the package will have contained the product within itself for at least several months and possibly up to several years.

5) Water Vapor Transmission Rate (WVTR)—This test method is mostly performed according to ASTM F1249-13 under the following test conditions: either the temperature of the test gas is 38° C. (±0.56° C.) and its relative humidity is 50% (±3%)—or if tropical conditions are required, the temperature of the test gas is set to 38° C. (±0.56° C.) and its relative humidity to 90% (±3%). The carrier gas is 100% N₂ (dry). The equipment used to run the test is a Permatran-W Water Vapor Permeability Instrument following the written procedure QMS 702-004. For materials outside of the Scope (§ 1.1) of ASTM F-1249-13, the water vapor transmission rate test method does not apply. If the barrier properties of a specific substrate is too poor, especially if coatings on paper substrates is very thin and did not enable a good seal to the equipment, then it is not possible to measure the WVTR via ASTM F1249-13. In those cases, a different test method is used i.e., ASTM E96 Cup Test Method. However, results from the two different test methods can still be compared. For ASTM E96, the temperature is 38° C. and the humidity is 90% relative humidity if tropical conditions are desired, or sometimes the humidity is 50% relative humidity if tropical conditions are not needed. For either test method, the water vapor transmission rate is reported in g/m²/day. If normalized by the barrier thickness, the water vapor transmission rate is reported in g·μm/m²/day.
6) Oxygen Transmission Rate (OTR)—This test method is mostly performed according to ASTM F1927 under the following test conditions: The temperature of the test gas is 23° C. (±0.56° C.) and its relative humidity is 80% (±3%) and the test gas concentration is 100% O₂, unless otherwise specified. The carrier gas is 98% N₂ and 2% H₂ and the carrier gas humidity is 0%. Test gas pressure is 760 mmHg. The equipment used to carry out this test is the Oxtran 2/21 Oxygen Permeability Instrument following the test procedure QMS 702-002. For either test method, the oxygen transmission rate is reported in cc/m²/day. If normalized by the barrier thickness, the water vapor transmission rate is reported in cc·μm/m²/day.
7) Individual layers thickness—The thickness of the individual layers is measured by cutting a 20 μm thick cross-section of a film sample via sliding microtome (e.g., Leica SM2010 R), placing it under an optical microscope in light transmission mode (e.g., Leica Diaplan), and applying an imaging analysis software. It is also measured using scanning electron microscopy which is also sometimes supplemented with energy-dispersive X-ray spectroscopy to give further contrast to the different layers.
8) Caliper—The caliper, or thickness, of a single-layer test sample is measured under a static load by a micrometer, in accordance with compendial method ISO 534, with modifications noted herein. All measurements are performed in a laboratory maintained at 23° C.±2° C. and 50%=2% relative humidity and test samples are conditioned in this environment for at least 2 hours prior to testing. Caliper is measured with a micrometer equipped with a pressure foot capable of exerting a steady pressure of 70 kPa±0.05 kPa onto the test sample. The micrometer is a dead-weight type instrument with readings accurate to 0.1 micron. A suitable instrument is the TMI Digital Micrometer Model 49-56, available from Testing Machines Inc., New Castle, DE, or equivalent.
9) Basis Weight—The basis weight of a test sample is the mass (in grams) per unit area (in square meters) of a single layer of material and is measured in accordance with compendial method ISO 536. The mass of the test sample is cut to a known area, and the mass of the sample is determined using an analytical balance accurate to 0.0001 grams. All measurements are performed in a laboratory maintained at 23° C.±2° C. and 50%±2% relative humidity and test samples are conditioned in this environment for at least 2 hours prior to testing.
10) Roughness Measurements (Sa) of Substrate/Individual Layers—Root Mean Square Roughness (Sq) is measured using a 3D Laser Scanning Confocal Microscope such as a Keyence VK-X200 series microscope available from KEYENCE CORPORATION OF AMERICA) which includes a VK-X200K controller and a VK-X210 30 Measuring Unit. The instrument manufacturer's software, VK Viewer version 2.4.1.0, is used for data collection and the manufacturer's software, Multifile Analyzer version 1.1.14.62 and VK Analyzer version 3.4.0.1, are used for data analysis. If needed, the manufacturer's image stitching software, VK Image Stitching version 2.1.0.0, can be used. The manufacturer's analysis software 15377P 22 is compliant with ISO 25178. The light source used is a semiconductor laser with a wavelength of 408 nm and having a power of about 0.95 mW.
11) Heat Seal Strength—ASTM F88-06 can be used to measure the heat seal strength of heat seals formed from the various barrier paper laminates, unless otherwise specified.

### Recyclability Testing

In order to facilitate, as well as to encourage the recyclability of the package, the package made from the structure of the present disclosure may comprise less than 50 percent by weight of inks, dyes, barrier layers, polymeric layers, glues and/or synthetic fibers. The weight percentage of inks, inks, dyes, barrier layers, polymeric layers, glues and/or synthetic fibers, in the package can be less than 50 percent by weight, less than 30 percent by weight, less than 10 percent by weight, specifically reciting all values within these ranges and any ranges created thereby. For example, the weight percentage of inks, dyes, barrier layers, polymeric layers, glues and/or synthetic fibers, in the package material can be between 0.1 percent by weight to 50 percent by weight, between 0.1 percent by weight to 30 percent by weight, between 0.1 percent by weight to 10 percent by weight, specifically reciting all values within these ranges and any ranges created thereby. In one specific example, the amount of inks, dyes, barrier layers, polymeric layers, glues and/or synthetic fibers, is 5 percent by weight or less or between 0.1 percent by weight to 5 percent by weight, specifically reciting all values within these ranges and any ranges created thereby. In the present invention the resulting overall package may be made from the biodegradable and recyclable barrier paper laminate described in the present disclosure comprises at least 50 percent by weight of natural cellulose fibers, at least 70 percent by weight natural cellulose fibers, or at least 80 percent by weight natural cellulose fibers, specifically reciting all values within these ranges and any ranges created thereby. The effectiveness of the recycling process on the package material of the present disclosure may be determined via recyclable percentage. Package material of the present disclosure can exhibit recyclable percentages of 50 percent or greater, 70 percent or greater, 80 percent or greater, specifically reciting all values within these ranges and any ranges created thereby. The packaging material of the present disclosure can have a recyclable percentage of between 50 percent to about 99 percent, from about 85 percent to about 99 percent, from about 90 percent to about 99 percent. The recyclable percentage of the package material of the present disclosure is determined via test PTS-RH: 021/97 (Draft October 2019) under category II as performed by Papiertechnische Stiftung located at Pirnaer Strasse 37, 01809 Heidenau, Germany. Along with recyclable percentage, the total reject percentage can be determined via PTS-RH: 021/97 (draft October 2019) under category II. The total reject percentage of the package material of the present disclosure can be less than about 50 percent, less than about 30 percent, less than about 10 percent, specifically including all values within these ranges and any ranges created thereby. For example, the total rejection percentage of the package material of the present disclosure can be from 0.5 percent to 50 percent, from 0.5 percent to 30 percent, from 0.5 percent to 10 percent, specifically reciting all values within these ranges and any ranges created thereby.

### Product Reformulation to Reduce Water Activity & Water Content

In the present invention, in order to prevent early hydrolysis of the biodegradable polymeric layer on the inside of the laminate sachet material that acts as the seal layer for the package (& subsequent damage deeper into the laminate's layered structure), it is necessary to reduce both the water activity and water content of the liquid food formulation—if it is not already in our preferred range of water activity. This is achieved by modifying a commercial marketed liquid food formulation, by removing any added water that does not come into the formula as part of another ingredient. Because there is a need for many foods to be liquid and to have a similar viscosity as commercial marketed liquid food (in order to be preferred by consumers), only flowable liquids and soluble solids are considered to replace the 29-41% added water in the marketed liquid foods. Because it is desired to not only reduce the water content, but also reduce the water activity (mobility) of the remaining water in the formula, ingredients that bind water (humectants) were evaluated. The chart below shows common humectants and the conditions where they reach equilibrium at different % water and relative humidity (Aw) conditions. At a liquid food water content of about 50% and at the average humidity for composition of interest (~75-80% RH), glycerin, propylene glycol and sodium chloride all have the ability to reduce water activity by binding with water. Propylene glycol causes formula separation at the level needed in the liquid food. However, replacing 29-41% water in the liquid food with a combination of both glycerin and sodium chloride results in a stable formula with both lower water content and activity.

### Non-Limiting Examples

The liquid food compositions illustrated in the following examples are prepared by conventional formulation and mixing methods. All exemplified amounts are listed as weight percent on an active basis and exclude minor materials such as diluents, preservatives, color solutions, imagery ingredients, botanicals, and so forth, unless otherwise specified. All percentages are based on weight unless otherwise specified.

### Food Composition Examples

Examples A through D were placed and sealed into packaging structure 7 and placed in 40 C/75% RH stability monitoring conditions.

| Ex. A | Ex. B | Ex. C | Ex. D |
|---|---|---|---|
| Honey¹ | Ketchup² + Honey1 | Fruit Spread³ | Peanut Butter⁴ |

Additional food compositions and modified food composition blend examples expected to be compatible with packaging structures based on Aw range.

| Brand | Product | Flavor | Aw |
|---|---|---|---|
| GoGo | Food Pouch | 50% Applesauce + | 0.896 |
| | | 50% Honey | |
| ⁴Skippy | Peanut Butter | Creamy | 0.334 |
| Justins | Almond Butter | Vanilla Almond | 0.339 |
| | | butter | |
| ²Heinz | Ketchup | Tomato Ketchup + | 0.865 |
| | | Honey | |
| ³Smuckers | Fruitspread | Squeeze- | 0.847 |
| | | Strawberry | |
| ¹Good & Gather | Honey | Organic | 0.596 |

### Biodegradable Flexible Structure Examples

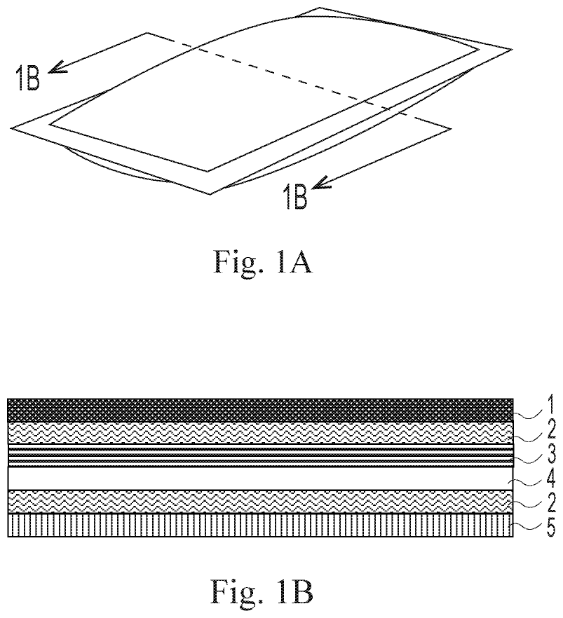

FIGS. 1 to 17 show eighteen non-limiting examples of biodegradable flexible structures that could be suitable for the current invention.

FIG. 1 shows Structure 1. The outside layer 1 of Structure 1 is a paper layer (where the basis weight is ~25 gsm); next is layer 2 that is a biodegradable adhesive; next is layer 3 that is a Natureflex NM cellulose-based film from Futamura which is ~23 μm thick, of which one side is metallized with layer 4 (a very thin aluminum metal layer that is laid down via vapor deposition) and forms the main moisture barrier for the package; next is a second layer 2 that is another layer of biodegradable adhesive; and the final layer is layer 5 that is an extruded film made from polybutylene succinate adipate (PBSA) that is ~30 μm thick and that acts as the sealant for the package. This biodegradable flexible structure is obtained from Parkside (United Kingdom) and is sold under the name “Triplex Laminate” and has the produce code “HCPT1(b)”. The structure passes both the OK Home Compost biodegradation test; the OK Industrial Compost biodegradation test and it also passes the OECD301B biodegradation test. It would also be expected to pass the ISO23832 test for Aerobic Biodegradation in Marine Sediment.

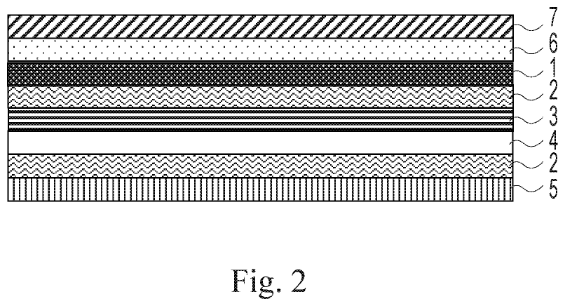

FIG. 2 shows Structure 2 which is the same as Structure 1 except that it is constructed by printing and varnishing Structure 1. The outside layer is layer 7 that is a varnish layer; the next layer is layer 6 that is a layer of printing inks; next is layer 1 that is a paper layer (where the basis weight is ~25 gsm); next is layer 2 that is a biodegradable adhesive; next is layer 3 that is a Natureflex NM cellulose-based film from Futamura of which one side is metallized with layer 4 (a very thin aluminum metal layer that is laid down via vapor deposition) which is ~23 μm thick and forms the main moisture barrier for the package; next is a second layer 2 that is another layer of biodegradable adhesive; and the final layer is layer 5 that is an extruded film made from polybutylene succinate adipate (PBSA) that is ~30 μm thick and that acts as the sealant for the package. The structure is expected to pass both the OK Home Compost biodegradation test; the OK Industrial Compost biodegradation test, the OECD301B biodegradation test and the ISO23832 test for Aerobic Biodegradation in Marine Sediment.

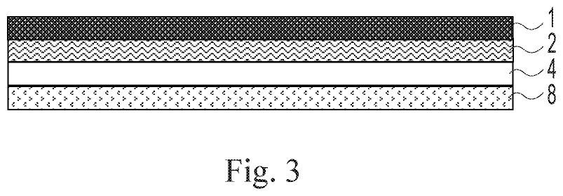

FIG. 3 shows Structure 3. The outside layer 1 is a paper layer; layer 2 is a biodegradable adhesive; layer 4 is a very thin aluminum metal layer that is laid down via vapor deposition onto layer 8 that is an extruded film made from BASF's Ecovio resin—that is a blend of polybutylene terephthalate (PBAT) & polylactic acid (PLA). The biodegradable flexible structure was obtained from Juratech (Germany) and the structure is named as “Jura Pro-Terra Laminate HEM-PBD”. Total thickness of the structure is ~126 μm and within that, the film is ~40 μm thick approximately. It is expected that the structure would pass both the OK Home Compost biodegradation test and the OK Industrial Compost biodegradation test.

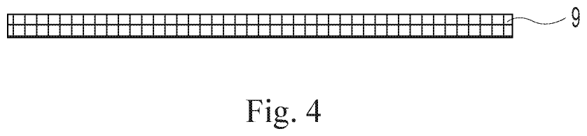

FIG. 4 shows Structure 4. This a one-layer structure—layer 9—it is an extruded film that is made on a film line from BASF's Ecovio resin that is a blend of polybutylene terephthalate (PBAT) & polylactic acid (PLA) with resin code F2341. The film is ~22 μm thick. This structure passes both the OK Home Compost biodegradation test and the OK Industrial Compost biodegradation test.

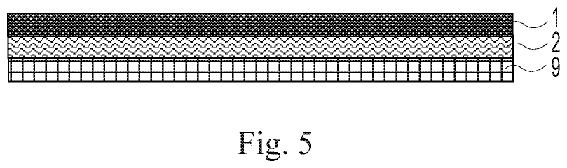

FIG. 5 shows Structure 5. The outside layer, layer 1 may be a paper layer; layer 2 may be a biodegradable adhesive; layer 9 may be an extruded film that may be from BASF's Ecovio resin that is a blend of polybutylene terephthalate (PBAT) & polylactic acid (PLA) with resin code F2341. It is expected that the structure would pass both the OK Home Compost biodegradation test and the OK Industrial Compost biodegradation test.

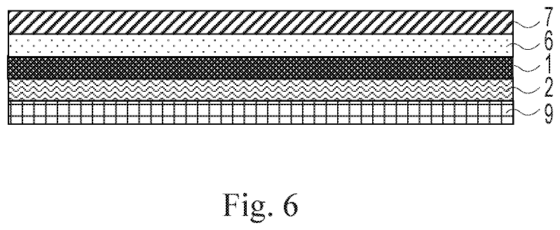

FIG. 6 shows Structure 6. The outside layer, layer 7, is a varnish layer; layer 6 is a layer of printing inks; layer 1 is a paper layer; layer 2 is a biodegradable adhesive; and layer 9 is an extruded film that may be made from BASF's Ecovio resin that is a blend of polybutylene terephthalate (PBAT) & polylactic acid (PLA) with resin code F2341.

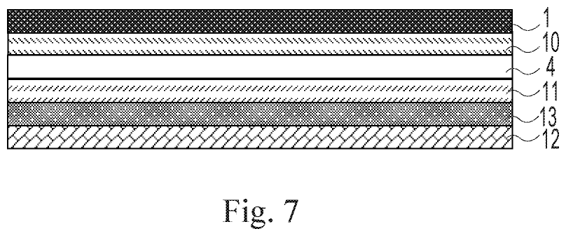

FIG. 7 shows Structure 7. The outside layer, layer 1 is a paper layer (~40 gsm); layer 10 is a layer of adhesive (~10 gsm); layer 4 is a very thin aluminum metal layer and forms the main moisture barrier for the package; layer 11 is a releasing coating; layer 13 is an anchor coating which is a polyurethane dispersion TAKELAC WPB-341 laid down onto the releasing layer in order to treat the releasing layer surface with suitable surface energy/tension in order to form a good bond with the heat sealant layer, layer 12, on top of it; and layer 12 is an extruded film made from PBAT which is ~34 μm thick and obtained from POLYROCK with the code name PBAT801T_POLYROCK, where the original PBAT resin was obtained from Tunhe. Alternatively, a blend of polybutylene terephthalate (PBAT) & polylactic acid (PLA), where the PLA content is ~10 wt % can be used and gives similar results for stability. Whichever sealant is used is heat laminated to the rest of the structure via a bench-top lamination. The total thickness of the structure formed is ~96 μm thick. When the heat sealant is made from PBAT, the entire structure passes both OECD301B and also passes the ISO23832 test for Aerobic Biodegradation in Marine Sediment and it is expected that the structure would pass both the OK Home Compost biodegradation test, the Australian Standard AS 5810—2010 for Biodegradable plastics—Biodegradable plastics suitable for home composting and also the OK Industrial Compost biodegradation test. When the heat sealant is alternatively made from a blend of polybutylene terephthalate (PBAT) & polylactic acid (PLA), where the PLA content is ~10 wt %, it would expect similar biodegradation results as what is mentioned above.

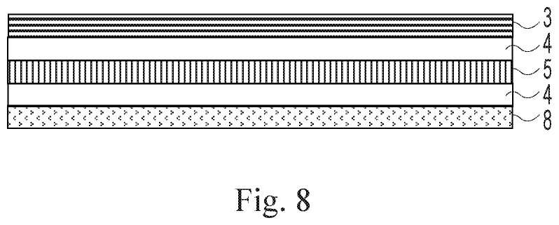

FIG. 8 shows Structure 8. The outside layer is layer 3 that is a Natureflex NM cellulose-based film from Futamura that is ~23 μm thick of which one side is metallized with layer 4 (a very thin aluminum metal layer that is laid down via vapor deposition) and forms one of the two main moisture barrier layers for the package—this part of the structure may be obtained from Futamura (USA); there is then layer 5 which is a thin extruded film (~7 μm thick) made from polybutylene succinate adipate (PBSA) and that functions as a layer to adhere the whole structure together; layer 4 is a very thin aluminum metal layer that is laid down via vapor deposition onto layer 8 that is an extruded film made from BASF's Ecovio resin that is a blend of polybutylene terephthalate (PBAT) & polylactic acid (PLA). It is expected that the structure would pass the OK Industrial Compost biodegradation test. The whole structure is thermally laminated together using a benchtop laminator. It is expected that the structure would pass the OK Industrial Compost biodegradation test.

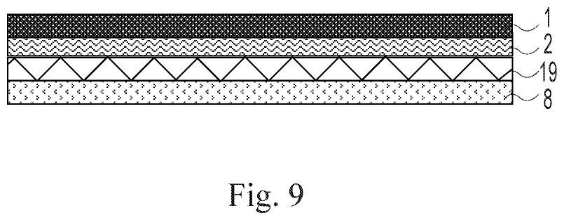

FIG. 9 shows Structure 9. The outside layer 1 is a paper layer; layer 2 is a biodegradable adhesive; layer 19 is a very thin aluminum oxide (AlOx) layer that is laid down via vapor deposition onto layer 8 that is an extruded film made from BASF's Ecovio resin that is a blend of polybutylene terephthalate (PBAT) & polylactic acid (PLA). It is expected that the structure would pass both the OK Home Compost biodegradation test and the OK Industrial Compost biodegradation test.

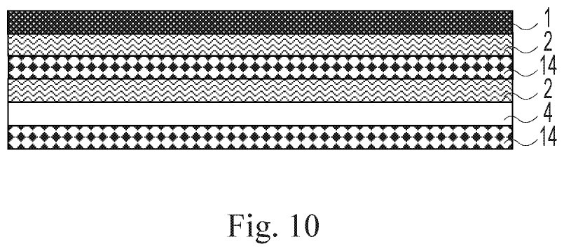

FIG. 10 shows Structure 10. The outside layer 1 is a paper layer; next is layer 2 that is a biodegradable adhesive; next is layer 14 that is a biaxially oriented film made from polylactic acid (PLA); next is a second layer of biodegradable adhesive—a second layer 2; next is layer 4 that is a very thin aluminum metal layer (that forms the main moisture barrier layer for the structure) that is laid down via vapor deposition onto layer 14 that is a biaxially oriented film made from polylactic acid (PLA) whose outer layer acts as the sealant for the package. It is expected that the structure would pass the OK Industrial Compost biodegradation test.

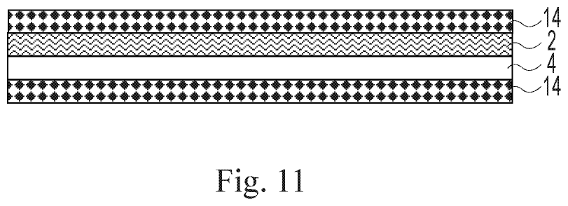

FIG. 11 shows Structure 11. The outside layer, layer 14, is a biaxially oriented film made from polylactic acid (PLA); layer 2 is a biodegradable adhesive; layer 4 is a very thin aluminum metal layer (that forms the main moisture barrier layer for the structure) that is laid down via vapor deposition onto layer 14 that is a biaxially oriented film made from polylactic acid whose outer layer acts as the sealant for the package. It is expected that the structure would pass the OK Industrial Compost biodegradation test.

FIG. 12 shows Structure 12. The outside layer is layer 3 that is a Natureflex NM cellulose-based film from Futamura of which one side is metallized with layer 4 (a very thin aluminum metal layer that is laid down via vapor deposition) and forms one of the two main moisture barrier layers for the package—this structure may be obtained from Futamura (USA); there is then a layer 5 which is a thin extruded film (~7 μm thick) made from polybutylene succinate adipate (PBSA) and that functions as a layer to adhere the whole structure together; layer 4 is a very thin aluminum metal layer (that forms the main moisture barrier layer for the structure) that is laid down via vapor deposition onto layer 14 that is a biaxially oriented film made from polylactic acid whose outer layer acts as the sealant for the package. The whole structure is thermally laminated together using a benchtop laminator). It is expected that the structure would pass the OK Industrial Compost biodegradation test.

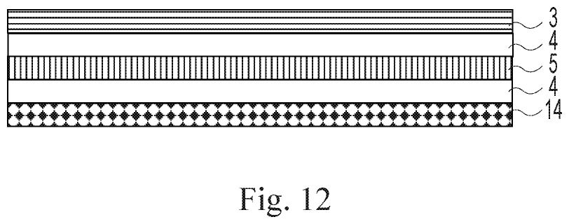

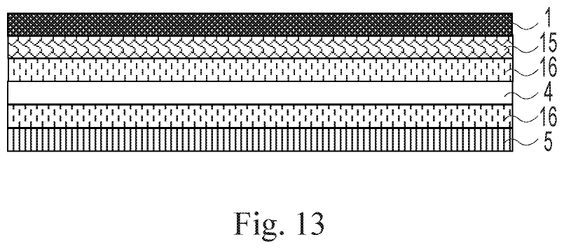

FIG. 13 shows Structure 13. The outside layer is layer 1 that is a paper layer; the next layer is layer 15 that is a PVOH coating layer laid down from an aqueous PVOH solution and then dried to remove the water; layer 16 is a bio-Ormocer primer layer that is laid down via solution coating and then dried to form a glass like film; layer 4 is a very thin aluminum metal layer (that forms the main moisture barrier layer for the structure) that is laid down via vapor deposition onto layer 16; there is then a second layer 16 which is a second bio-Ormocer primer layer that is laid down to protect the metallized layer; layer 5 is then an extruded film made from polybutylene succinate adipate (PBSA) that is thermally laminated to the rest of the structure and acts as the sealant for the package.

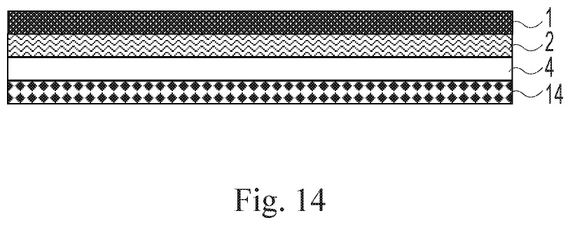

FIG. 14 shows Structure 14. The outside layer is layer 1 that is a paper layer; the next layer is layer 2 that is a biodegradable adhesive; layer 4 is a very thin aluminum metal layer (that forms the main moisture barrier layer for the structure) that is laid down via vapor deposition onto layer 14 that is a biaxially oriented film made from polylactic acid whose outer layer acts as the sealant for the package. It is expected that the structure would pass the OK Industrial Compost biodegradation test.

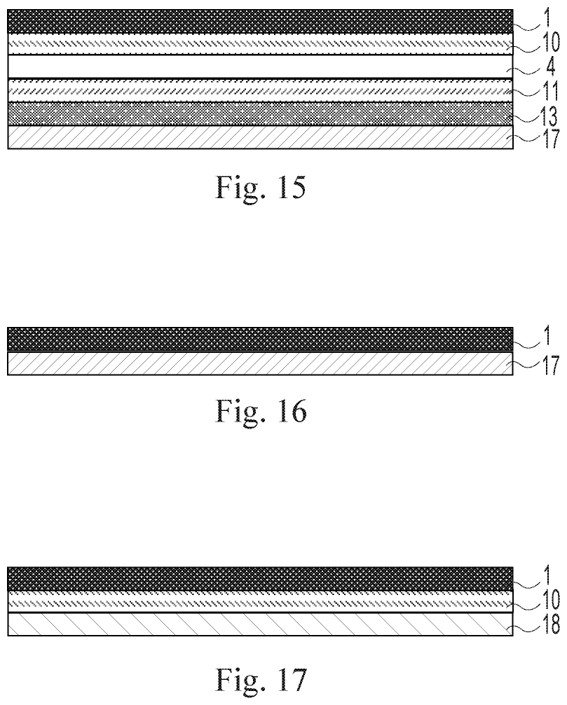

FIG. 15 shows Structure 15. The outside layer, layer 1 is a paper layer (~40 gsm); layer 10 is a layer of adhesive (~10 gsm); layer 4 is a very thin aluminum metal layer and forms the main moisture barrier for the package; layer 11 is a releasing coating; layer 13 such as an anchor coating which is a polyurethane dispersion TAKELAC WPB-341 laid down onto the releasing layer in order to treat the releasing layer surface with suitable surface energy/tension in order to form a good bond with the heat sealant layer, layer 12, on top of it; and layer 12 is a coating layer made from small particles made up of any of the biodegradable polymers mentioned in the section “WATER IN-SOLUBLE BIODEGRADABLE POLYMERS FOR SEALANT LAYERS AND OTHER LAYERS” or in the section “BIODEGRADABLE POLYMERS THAT ARE WATER-SOLUBLE” which is applied as in the form of either an emulsion of the particles or in dry particle form. After applying the coating, the substrate is then heated to melt the particles into a continuous layer. The structure would be expected to pass the OECD301B test, the ISO23832 test for Aerobic Biodegradation in Marine Sediment, the OK Home Compost biodegradation test, the Australian Standard AS 5810—2010 for Biodegradable plastics—Biodegradable plastics suitable for home composting and also the OK Industrial Compost biodegradation test.

FIG. 16 shows structure 16. The outside layer, layer 1 may be a paper layer; layer 17 is a biodegradable sealant coating layer made from small particles made up of any of the biodegradable polymers mentioned in the section “WATER IN-SOLUBLE BIODEGRADABLE POLYMERS FOR SEALANT LAYERS AND OTHER LAYERS” or in the section “BIODEGRADABLE POLYMERS THAT ARE WATER-SOLUBLE” which is applied as in the form of either an emulsion of the particles or in dry particle form. After applying the coating, the substrate is then heated to melt the particles into a continuous layer. The structure would be expected to pass the OECD301B test, the ISO23832 test for Aerobic Biodegradation in Marine Sediment, the OK Home Compost biodegradation test, the Australian Standard AS 5810—2010 for Biodegradable plastics—Biodegradable plastics suitable for home composting and also the OK Industrial Compost biodegradation test.

FIG. 17 shows structure 17. The outside layer, layer 1 may be a paper layer; layer 10 may be a biodegradable adhesive; layer 18 is a PBAT film which includes 5-15 wt % talc and other slip agent and is substantially free of PLA. The structure would be expected to pass the OECD301B test, the ISO23832 test for Aerobic Biodegradation in Marine Sediment, the OK Home Compost biodegradation test, the Australian Standard AS 5810—2010 for Biodegradable plastics—Biodegradable plastics suitable for home composting and also the OK Industrial Compost biodegradation test.

### Stability Results for Package and Formula Combinations

a) Stability Results for Reference In-Market Package—For reference-note that a traditional liquid food packaged inside the current in-market package made from one of the current in-market flexible structures typically used for foods would be expected to lose <0.2 wt % over 4 weeks at 40° C./75% RH. Such a flexible structure is typically made from non-biodegradable materials with the following structure—an outer layer of polyethylene terephthalate (PET) which is reverse printed with inks to display the necessary artworks; which is adhesively laminated to a layer of metallized biaxially oriented polypropylene (BOPP) to provide barrier properties; which in turn is adhesively laminated to a layer of polyethylene (PE) which acts as the sealant for the package. In some cases, where even better barrier is required, instead of utilizing a metallized biaxially oriented polypropylene barrier, a layer of aluminum foil may be used instead. We refer to this structure as Structure 0. Although this structure provides good barrier properties and minimizes weight loss from the package, the flexible structure used to make the package is not biodegradable and so this combination does not solve the problem that the present invention solves. Structure 0 in Table X refers to this non-biodegradable flexible structure.

b) Stability Results for a variety of foods with low water activity inside our lead Biodegradable Flexible Structure: In addition, non-limiting examples of combinations of other flexible packaging structures and formulations have also been considered. FIGS. 1b to 18 show diagrams of 17 examples of biodegradable flexible structures that might be suitable for containing such liquid foods. The weight change from these different products packaged inside our lead packaging structure results are summarized in the table below.

### The Below Table Shows the Weight Gain/Weight Loss Observed for Different Combinations of Formula & Our Lead Package:

Formula examples refer to the non-limiting formula example table, where examples of liquid foods with low water activity are shown. The table shows that when tested for 4 weeks stored at 40 C/75% RH in these package structures, the low Aw formula examples have less than 10% weight change and so would be expected to be stable in these packages.

| | | Ex. B | Ex. C | Ex. D |
|---|---|---|---|---|
| Formula/ | Ex. A | Ketchup + | Fruit | Peanut |
| Package Structure | Honey | Honey | Spread | Butter |
| Structure 1 | n/a | n/a | n/a | n/a |
| Structure 2 | n/a | n/a | n/a | n/a |
| Structure 3 | n/a | n/a | n/a | n/a |
| Structure 4 | n/a | n/a | n/a | n/a |
| Structure 5 | n/a | n/a | n/a | n/a |
| Structure 6 | n/a | n/a | n/a | n/a |
| Structure 7 | −0.9% | 2.1% | 2 wt % | −2.4% |
| | (gain) | (loss) | (loss) | (gain) |
| Structure 8 | n/a | n/a | n/a | n/a |
| Structure 9 | n/a | n/a | n/a | n/a |
| Structure 10 | n/a | n/a | n/a | n/a |
| Structure 11 | n/a | n/a | n/a | n/a |
| Structure 12 | n/a | n/a | n/a | n/a |
| Structure 13 | n/a | n/a | n/a | n/a |
| Structure 14 | n/a | n/a | n/a | n/a |
| Structure 16 | n/a | n/a | n/a | n/a |
| Structure 17 | n/a | n/a | n/a | n/a |
| Structure 18 | n/a | n/a | n/a | n/a |
| Structure 0 * | Expect | Expect | Expect | Expect |
| | <0.2 wt % | <0.2 wt % | <0.2 wt % | <0.2 wt % |
| | (loss) | (loss) | (loss) | (loss) |

* Structure 0 is a commercially available laminate used to make a food sachet

### ADDITIONAL EXAMPLES/COMBINATIONS

A. A biodegradable flexible package in combination with a liquid food composition comprising:
a) a package comprising at least one biodegradable polymeric layer and an inorganic layer; and
b) a liquid food composition comprising from about 0% to about 50% water and from about 0% to about 50% of a humectant;
wherein there is a Water Activity (Aw) of about 0.30 to about 0.90.
   B. The biodegradable flexible package according to Paragraph A, wherein the package comprises additional layers selected from the group consisting of at least 3 layers, at least 4 layers, at least 5 layers or at least 6 layers.
   C. The biodegradable flexible package according to Paragraphs A-B, wherein the package comprises greater than 6 layers.
   D. The biodegradable flexible package according to Paragraphs A-C, wherein at least one of the additional layers is selected from the group consisting of a paper layer, a cellulose layer, a biodegradable adhesive layer, a second inorganic layer, a second biodegradable polymeric layer, a primer layer, an ink layer, a varnish layer and mixtures thereof.
   E. The biodegradable flexible package according to Paragraphs A-D, wherein the biodegradable polymeric layer is from the group consisting of polybutylene succinate adipate (PBSA), polybutylene succinate (PBS), polybutylene terephthalate (PBAT), Polyhydroxyalkanoate (PHA), polylactic acid (PLA), cellulosic polymer or blends thereof.
   F. The biodegradable flexible package according to Paragraphs A-E, wherein the inorganic layer comprises a vapor deposited aluminum layer laid down onto either a paper layer, a cellulose layer, a biodegradable polymeric layer, a second biodegradable polymeric layer or a primer layer.
   G. The biodegradable flexible package according to Paragraphs A-F, wherein the inorganic layer is laid down by vapor deposition is a material is selected from the group consisting of metal oxides, SiOx (glass like material), aluminum oxides (e.g., Al₂O₃), aluminum carbide, aluminum nitride, magnesium oxide, titanium oxides (such as titanium dioxide, titanium(3) oxide or titanium monoxide), zinc oxide, tin oxide, yttrium oxide, or zirconium oxides (e.g., zirconium monoxide), calcium oxide, boron oxide; or metalloid oxides such as silicon oxides, silicon oxycarbides, and silicon nitrides; or diamond like coatings (DLC). Silicon oxide or nitride-based coatings could also be one selected from the group consisting of SiOx (where x is an integer of 1-4) or SiOxNy (where each of x and y is an integer of 1-3).
   H. The biodegradable flexible package according to Paragraphs A-G, wherein the inorganic layer comprises an aluminum layer is attached to either a paper layer, a cellulose layer, a biodegradable polymeric layer, a second biodegradable polymeric layer, a primer layer, or a biodegradable adhesive layer, via an indirect transfer metallization process.
   I. The biodegradable flexible package according to Paragraphs A-H, wherein the inorganic layer comprises a clay, or a nanoclay or an inorganic-organic hybrid polymer and is laid down onto a paper layer, a cellulose layer, a biodegradable polymeric layer, a second biodegradable polymeric layer or a primer layer, from an aqueous dispersion via an aqueous coating process followed by drying.
   J. The biodegradable flexible package according to Paragraphs A-I, wherein the biodegradable polymeric layer comprises polybutylene succinate adipate (PBSA), and wherein at least one of the additional layers comprises a paper, a biodegradable adhesive layer, and an inorganic layer that is aluminum, that is laid down onto a second biodegradable polymeric layer comprising a cellulosic polymer.
   K. The biodegradable flexible package according to Paragraphs A-J, wherein at least one of the additional layers comprises a paper, a biodegradable adhesive layer, and an inorganic layer that is aluminum, laid down onto the biodegradable polymeric layer comprising a blend of polybutylene terephthalate (PBAT) and polylactic acid (PLA).
   L. The biodegradable flexible package according to Paragraphs A-K, wherein the biodegradable adhesive layer is selected from the group consisting biodegradable polyvinyl acetates, starches, maltodextrins, natural waxes, artificial waxes, polyester-polyurethane, poly vinyl alcohol, polyethylene oxide or blends and mixtures thereof.
   M. The biodegradable flexible package according to Paragraphs A-L, wherein the liquid food composition comprises from about 14% to about 50% water.
   N. The biodegradable flexible package according to Paragraphs A-M, wherein the food composition comprises from about 20% to about 50% of a humectant.
   O. The biodegradable flexible package according to Paragraphs A-N, wherein the food composition comprises from about 23% to about 45% of a humectant.
   P. The biodegradable flexible package according to Paragraphs A-O, wherein the food composition is selected from ketchup, honey, fruit spread or jelly, peanut butter, mayonnaise, mustard, applesauce, hot sauce, jams, jellies, marmalades, sandwich spreads, sauces, salad dressings, seasonings, condiments, and combinations thereof.
   Q. The biodegradable flexible package according to Paragraphs A-P, wherein the food composition is ketchup.
   R. The biodegradable flexible package according to Paragraphs A-Q, wherein the package is a single use package that holds from about 0.25 ounces to about 2.0 ounces.
   S. The biodegradable flexible package according to Paragraphs A-R, wherein the biodegradable package is a sachet.
   T. The biodegradable flexible package according to Paragraphs A-S, wherein the humectant is selected from glycerin, erythritol, 1,2-propanediol (any isomer), ethanol, sorbitol, threitol; dihydroxyacetone; 1,3-propandiol (any isomer); 1,2,3-butanetriol (any isomer); 1,2,4 butanetriol (any isomer); 1,2 butanediol (any isomer); 2,3 butanediol (any isomer); arabitol; xylitol; ribitol; mannitol; galactitol; fucitol; iditol; inositol; volemitol; isomalt; maltitol; lactitol; maltotriitol; maltotetraitol; polyglycitol; polyethylene glycol (PEG) (all chains lengths), methoxy polyethylene glycols; sugar alcohols; glucose, fructose, sucrose, mannose, corn syrup, all other non-toxic diols or triols; hydrogenated sugars or sugar derivatives; non-toxic aminoalcohols and all related diols and triols derivatives including esters, ketone or aldehydic derivatives; yeast extract; ionic salts, sodium chloride, potassium chloride; honey; and mixtures thereof.

U. The biodegradable flexible package according to Paragraphs A-T, wherein the humectant is selected from the group consisting of glycerin, honey, corn syrup, and mixtures thereof.

V. The biodegradable flexible package according to Paragraphs A-U, wherein the Water Activity (Aw) is from about 0.60 to about 0.85.
W. The biodegradable flexible package according to Paragraphs A-V, wherein the Water Activity (Aw) is from about 0.8 to 0.9.
X. The biodegradable flexible package according to Paragraphs A-W, wherein the liquid personal care composition comprises a food thickening agent.
Y. The biodegradable flexible package according to Paragraphs A-X, wherein the liquid food composition comprises a food thickening agent sourced from a material selected from guar gum; xanthan gum; whey protein; soy protein; seeds, seed gums, seed extracts, moringa, jackfruit, tomato, alyssum; corn starch; tapioca starch; rice flour; microalgae, cellulose, polysaccharides, and glucan.
Z. The biodegradable flexible package according to Paragraphs A-Y, wherein the liquid food composition has a viscosity of from about 2,000 to about 200,000 cps.
AA. The biodegradable flexible package according to Paragraphs A-Z, wherein the biodegradable polymeric layer acting as a sealant is not water soluble.
BB. The biodegradable flexible package according to Paragraphs A-AA, wherein there is a secondary package surrounding the biodegradable flexible package.
CC. A biodegradable flexible package in combination with a liquid food composition comprising:
a) a package comprising at least one biodegradable polymeric layer;
b) a liquid food composition comprising from about 0% to about 50% water; from about 0% to about 50% of a humectant; wherein there is a Water Activity (Aw) of about 0.30 to about 0.80.
   DD. The biodegradable flexible package according to Paragraph CC, wherein the food composition further comprises from about 20% to about 50% of a humectant.
   EE. The biodegradable flexible package according to Paragraphs CC-DD, wherein the package comprises additional layers selected from the group consisting of a paper layer, a biodegradable adhesive layer, a second biodegradable polymeric layer, an ink layer, a varnish layer and mixtures thereof.
   FF. The biodegradable flexible package according to Paragraphs CC-EE, wherein the biodegradable polymeric layer is from the group consisting of polybutylene succinate adipate (PBSA), polybutylene succinate (PBS), polybutylene terephthalate (PBAT), Polyhydroxyalkanoate (PHA), polylactic acid (PLA), cellulosic polymer; or blends thereof.
   GG. The biodegradable flexible package according to Paragraphs CC-FF, wherein the biodegradable adhesive layer is selected from the group consisting of biodegradable polyvinyl acetates, starches, maltodextrins, natural waxes, artificial waxes, polyester-polyurethane, poly vinyl alcohol, polyethylene oxide; or blends and mixtures thereof.
   HH. The biodegradable flexible package according to Paragraphs CC-GG, wherein the package comprises at least a paper layer and a biodegradable polymeric layer comprising polybutylene terephthalate (PBAT) or blends thereof with polybutylene succinate adipate (PBSA), polybutylene succinate (PBS), polyhydroxyalkanoate (PHA) or polylactic acid (PLA).
   II. The biodegradable flexible package according to Paragraphs CC-HH, wherein the biodegradable package is a sachet.
   JJ. A biodegradable flexible package in combination with a liquid food composition, wherein the liquid food composition gains water when packaged inside the package, wherein a total weight gain of the package is not more than 10 wt % over 1 month at 40 C & 75% relative humidity (RH).
   KK. A biodegradable flexible package in combination with a liquid food composition, wherein the liquid food composition gains water when packaged inside the package, wherein the liquid food composition gain of water enables the physical or chemical properties of a final formulation of the liquid food composition.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A biodegradable flexible package in combination with a liquid food composition comprising:
a) a package comprising at least one biodegradable polymeric layer and an inorganic layer; and
b) a liquid food composition comprising from about 0% to about 50% water and from about 0% to about 50% of a humectant;
wherein there is a Water Activity (Aw) of about 0.30 to about 0.90.

2. A biodegradable flexible package according to claim 1 wherein the package comprises additional layers selected from the group consisting of at least 3 layers, at least 4 layers, at least 5 layers or at least 6 layers.

3. A biodegradable flexible package according to claim 2 wherein at least one of the additional layers is selected from the group consisting of a paper layer, a cellulose layer, a biodegradable adhesive layer, a releasing layer, an anchor coating, a second inorganic layer, a second biodegradable polymeric layer, a primer layer, an ink layer, a varnish layer, and mixtures thereof.

4. A biodegradable flexible package according to claim 1 wherein the biodegradable polymeric layer is selected from the group consisting of polybutylene succinate adipate (PBSA), polybutylene succinate (PBS), polybutylene terephthalate (PBAT), Polyhydroxyalkanoate (PHA), polylactic acid (PLA), Polypropylene carbonate (PPC) and its copolymers, cellulosic polymer or blends thereof.

5. A biodegradable flexible package according to claim 1 wherein the inorganic layer comprises a vapor deposited aluminum layer laid down onto either a paper layer, a cellulose layer, a biodegradable polymeric layer, a second biodegradable polymeric layer or a primer layer.

6. A biodegradable flexible package according to claim 1 wherein the inorganic layer is laid down by vapor deposition and is a material selected from the group consisting of metal oxides, SiOx (glass-like material), aluminum oxides, aluminum carbide, aluminum nitride, magnesium oxide, titanium oxides, zinc oxide, tin oxide, yttrium oxide, zirconium oxides, calcium oxide, boron oxide, metalloid oxides, silicon oxycarbides, silicon nitrides, diamond like coatings (DLC), and combinations thereof.

7. A biodegradable flexible package according to claim 1 wherein the inorganic layer comprises an aluminum layer that is attached to either a paper layer, a cellulose layer, a biodegradable polymeric layer, an adhesive layer, a releasing layer or a second biodegradable polymeric layer.

8. A biodegradable flexible package according to claim 1 wherein the inorganic layer comprises an aluminum layer which is transferred by an indirect transfer metallization process.

9. A biodegradable flexible package according to claim 1 wherein the inorganic layer comprises a clay, or a nanoclay or an inorganic-organic hybrid polymer and is laid down onto a paper layer, a cellulose layer, a biodegradable polymeric layer, a second biodegradable polymeric layer or a primer layer, from an aqueous dispersion via an aqueous coating process followed by drying.

10. A biodegradable flexible package according to claim 2 where the biodegradable polymeric layer comprises polybutylene succinate adipate (PBSA), and wherein at least one of the additional layers comprises a paper, a biodegradable adhesive layer, and an inorganic layer that is aluminum, that is laid down onto a second biodegradable polymeric layer comprising a cellulosic polymer.

11. A biodegradable flexible package according to claim 2 wherein at least one of the additional layers comprises a paper, an adhesive layer, an inorganic layer that is aluminum, a releasing layer, an anchor coating, and a biodegradable polymeric layer comprising either polybutylene terephthalate (PBAT) or a blend of polybutylene terephthalate (PBAT) and polylactic acid (PLA).

12. A biodegradable flexible package according to claim 1 wherein the liquid food composition comprises from about 14% to about 50% water.

13. A biodegradable flexible package according to claim 1, wherein the food composition comprises from about 23% to about 45% of a humectant.

14. A biodegradable flexible package according to claim 1, wherein the food composition is selected from ketchup, honey, fruit spread or jelly, peanut butter, mayonnaise, mustard, applesauce, hot sauce, jams, jellies, marmalades, sandwich spreads, sauces, salad dressings, seasonings, condiments, and combinations thereof.

15. A biodegradable flexible package according to claim 1, wherein the package is a single use package that holds from about 0.25 ounces to about 2.0 ounces.

16. A biodegradable flexible package according to claim 1 wherein the biodegradable package is a sachet.

17. A biodegradable flexible package according to claim 1 wherein the humectant is selected from the group consisting of glycerin, honey, corn syrup, and mixtures thereof.

18. A biodegradable flexible package according to claim 1 wherein the Water Activity (Aw) is from about 0.60 to about 0.85.

19. A biodegradable flexible package according to claim 1 wherein the Water Activity (Aw) is from about 0.8 to 0.9.

20. A biodegradable flexible package according to claim 1 wherein the liquid food composition comprises a food thickening agent sourced from a material selected from guar gum; xanthan gum; whey protein; soy protein; seeds, seed gums, seed extracts, moringa, jackfruit, tomato, alyssum; corn starch; tapioca starch; rice flour; microalgae, cellulose, polysaccharides, and glucan.

21. A biodegradable flexible package in combination with a liquid food composition comprising:
a) a package comprising at least one biodegradable polymeric layer;
b) a liquid food composition comprising from about 0% to about 50% water; from about 0% to about 50% of a humectant; wherein there is a Water Activity (Aw) of about 0.30 to about 0.80.
